(19) United States
(12) Patent Application Publication
(10) Pub. No.: US 2026/0170830 A1
(43) Pub. Date: Jun. 18, 2026

(54) USE OF DOMAIN SPECIFIC VLLMS TO INTERPRET VIDEO CONTENT

(71) Applicant: Cynapse Pte. Ltd., Singapore (SG)

(72) Inventors: Guy Ron, Singapore (SG); Noam Berda, Singapore (SG); Prabodh Tripathi, Singapore (SG); Hizkia Felix, Singapore (SG); Nitin Gururaj Kallur, Singapore (SG)

(21) Appl. No.: 19/231,267

(22) Filed: Jun. 6, 2025

Related U.S. Application Data
(63) Continuation-in-part of application No. 19/231,199, filed on Jun. 6, 2025.
(63) Continuation of application No. 19/223,940, filed on May 30, 2025.
Application No. 19/223,940 is a continuation-in-part of application No. 18/981,227, filed on Dec. 13, 2024.

(51) Int. Cl. G06V 20/40; G06V 10/26; G06V 10/70; G06V 10/72; G06V 10/82; G06V 20/52

(52) U.S. Cl. CPC G06V 20/41; G06V 10/26; G06V 10/72; G06V 10/768; G06V 10/82; G06V 20/46; G06V 20/52

(57) ABSTRACT

A multi-tiered video content understanding system includes a frame preprocessing module that receives encoded video, decodes it to create a decoded video, and selects key frames corresponding to a scene. A scene understanding module, comprising three tiers, receives these key frames. The first tier, e.g., isolates an object in the scene by detecting and segmenting the object in at least one key frame and applying computer vision logic to identify object information. The second tier includes a VLM that vectorizes key frames containing the object to create a vectorized object images. The third tier includes a vision large language module (VLLM) that generates a contextual description of the scene using the vectorized object image and/or object information. The scene understanding module outputs a detailed frame document that is generated using outputs from each of the three tiers.

This application claims priority to and is a continuation-in-part of U.S. patent application No. 19/231,199 filed Jun. 6, 2025, which claims priority to and is a continuation-in-part of U.S. patent application Ser. No. 18/981,227 filed Dec. 13, 2024. All extrinsic materials identified in this application are incorporated by reference in their entirety.

### FIELD OF THE INVENTION

The field of the invention is using VLM and VLLMs to generate comprehensive and contextualized understandings of video content.

### BACKGROUND

The background description includes information that may be useful in understanding the present invention. It is not an admission that any of the information provided in this application is prior art or relevant to the presently claimed invention, or that any publication specifically or implicitly referenced is prior art.

Scene understanding has traditionally been achieved through the use of machine learning and computer vision models, including detectors, classifiers, and segmentation models. These models analyze visual data to recognize the presence, location, and boundaries of specific objects. Traditional scene understanding tools, which include detectors, classifiers, and segmentation models, have limitations such as needing fine-tuning for specific use cases, providing only object-level understanding, lacking general context of the scene, and not inherently understanding object-object interactions.

Although existing technologies can nevertheless be useful for things like object search based on object attributes, generating alerts based on object attributes, and triggering alerts based on object-object interactions, traditional scene understanding tools are limited in their inability to perform comprehensive scene analysis and provide a detailed breakdown of the objects in the scene.

With the advent of Large Language Models (LLMs) and Open Vocabulary Vision Language Model (sometimes referred to as Vision Language models, or VLMs), scene understanding can improved by prompting VLLMs with both images and text. But these models lack capabilities in localizing objects as well as identifying object-object relationships. Moreover, VLLMs require immense processing power. Thus, there exists a need in the art for improved scene understanding that leverages large language models to carry out object detection, object attribute classification, and to determine object-object interactions to create detailed descriptions and searchable text for video-based events that can operate in real time on live video without any VLLM-based slowdown.

### SUMMARY OF THE INVENTION

The present invention provides apparatus, systems, and methods directed to video interpretation using VLLMs. In one aspect of the inventive subject matter, a method of selecting frames from video content, preprocessing the frames, and analyzing video content based on the frames is contemplated. The method includes the steps of: receiving, at a frame preprocessing module, video from a surveillance camera, wherein the video is encoded; decoding the video to create a decoded video; selecting key frames from the decoded video at a key frame sampling rate; developing runtime insights for each key frame to determine a set of preprocessing techniques relevant to the key frames; applying at least one preprocessing technique from the set of preprocessing techniques each of the key frames according to the runtime insights associated with each key frame to create a preprocessed key frame; streaming, from the frame preprocessing module, a series of preprocessed key frames to a scene understanding module, the scene understanding module comprising a first tier, a second tier, and a third tier; wherein the scene understanding module processes the series of preprocessed key frames in real time as each preprocessed key frame is streamed from the frame preprocessing module; carrying out first tier processing on the series of preprocessed key frames by detecting an object in each preprocessed key frame, for each preprocessed key frame, segmenting the object into a segmented object image, and for each preprocessed key frame, generating object information by applying a computer vision logic system to the segmented object image; carrying out second tier processing on the series of preprocessed key frames by vectorizing at least a portion of each preprocessed key frame; carrying out third tier processing on the series of preprocessed key frames by using a VLLM to generate a contextual description of the video using a vectorized portion of each preprocessed key frame; and wherein the scene understanding module outputs a detailed frame document comprising the contextual description of the scene and the vectorized portion of each preprocessed key frame.

In some embodiments, the portion of each preprocessed key frame comprises the segmented object image. The at least one preprocessing technique can include one or any combination of de-noising, de-blurring, exposure correction, backlight correction, de-raining, de-glaring, sharpening, dehazing, super-resolution, low-light enhancement, and reflection removal. The at least one preprocessing technique can include de-noising that is performed using a Gaussian noise reduction algorithm, a Fourier transform-based de-blurring approach, an exposure correction that applies histogram equalization techniques, reflection removal carried out through polarization-based filtering techniques, and super-resolution based on deep convolutional neural networks (CNNs). In some embodiments, the frame preprocessing module features parallel processing units for simultaneous application of multiple preprocessing techniques.

In another aspect of the inventive subject matter, a method of selecting frames from video content, preprocessing the frames, and analyzing the video content based on the frames is contemplated. The method comprises the steps of: receiving, at a frame preprocessing module, video from a camera; selecting key frames from the video at a first key frame sampling rate; generating runtime insights for each key frame; changing, based on the runtime insights, the first key frame sampling rate to a second key sampling rate, wherein the second key frame sampling rate is higher than the first key frame sampling rate; identifying, based on the runtime insights, at least one preprocessing technique to apply to each of the key frames; applying at least one preprocessing technique to each of the key frames according to the runtime insights associated with each of the key frames to create a preprocessed key frame corresponding to each of the key frames; streaming, from the frame preprocessing module, preprocessed key frames to a scene understanding module; and wherein the scene understanding module outputs a detailed frame document comprising a contextual description of the video.

In some embodiments, the runtime insights include at least one of brightness information, lens distortion information, and region of interest information. The at least one preprocessing technique can include at least one of de-noising, de-blurring, exposure correction, backlight correction, de-raining, de-glaring, sharpening, dehazing, super-resolution, low-light enhancement, and reflection removal. The at least one preprocessing technique can include de-noising that is performed using a Gaussian noise reduction algorithm, a Fourier transform-based de-blurring approach, an exposure correction that applies histogram equalization techniques, reflection removal carried out through polarization-based filtering techniques, and super-resolution based on deep convolutional neural networks (CNNs). In some embodiments, the frame preprocessing module features parallel processing units for simultaneous application of multiple preprocessing techniques.

One should appreciate that the disclosed subject matter provides many advantageous technical effects including the ability to generate contextualized information about video content in real-time.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic showing how different video sources can feed video content into a frame preprocessing module of the inventive subject matter.

FIG. 2 is a schematic describing frame preprocessing that occurs before passing video content on to a scene understanding module.

FIG. 3 is a schematic of a frame preprocessing module of the inventive subject matter.

FIG. 4 is a schematic describing a scene understanding module of the inventive subject matter.

FIG. 5 is a flowchart describing a method of the inventive subject matter focusing on frame preprocessing and a scene understanding module.

FIG. 6 is a flowchart showing an output from a scene understanding module.

FIG. 7 is a flowchart showing possible inputs to VLLMs along with outputs that can result.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used in the description in this application and throughout the claims that follow, the meaning of “a,” “an,” and “the” includes plural reference unless the context clearly dictates otherwise. Also, as used in the description in this application, the meaning of “in” includes “in” and “on” unless the context clearly dictates otherwise.

It should be noted that any language directed to a computer should be read to include any suitable combination of computing devices, including servers, interfaces, systems, databases, agents, peers, Engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network. The following description includes information that may be useful in understanding the present invention. It is not an admission that any of the information provided in this application is prior art or relevant to the presently claimed invention, or that any publication specifically or implicitly referenced is prior art.

In this application, the phrasing “at least one of X, Y, and Z” may be used. This usage is intended to mean “one or more of X, one or more of Y, or one or more of Z, or any combination of one or more of X, one or more of Y, and one or more of Z.”

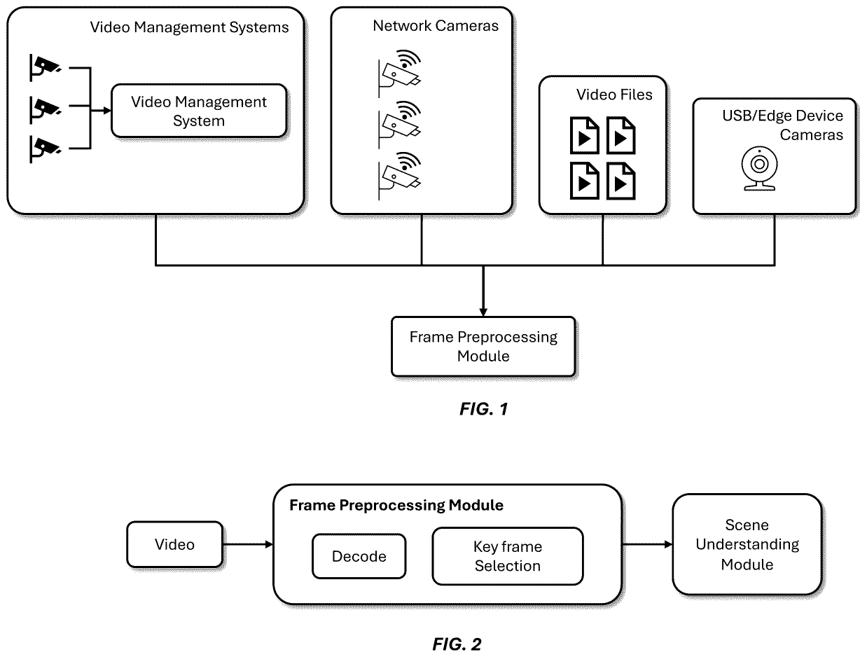

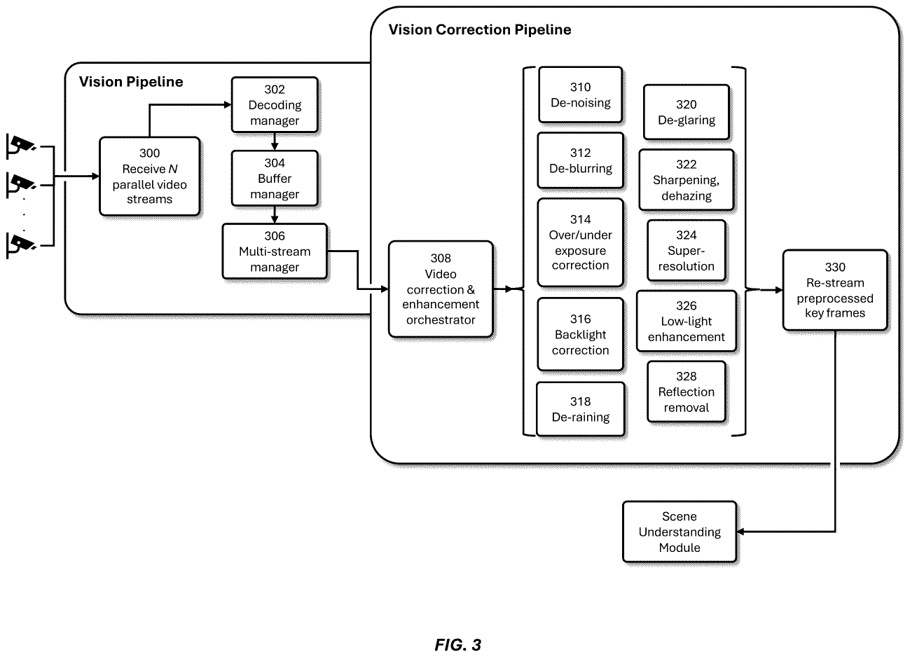

Systems and methods of the inventive subject matter take a three-tiered approach to scene understanding that includes tools to obtain deep insights of scenes that exist within videos. FIG. 1 is a schematic showing how different video sources can feed video content into a frame preprocessing module of the inventive subject matter. FIG. 2 is a schematic describing frame preprocessing that occurs before passing video content on to a scene understanding module that is described in FIG. 3.

According to FIG. 1, video content can come from a variety of sources. For example, a Video Management System (VMS) can provide video. Camera feeds are often managed by a VMS, which is responsible for recording video streams, changing settings, and providing camera feed access to external service providers. Camera feeds from a VMS can thus be fed into a frame preprocessing module of the inventive subject matter. Camera systems that can act as video sources include surveillance cameras used by security personnel to monitor one or a set of locations.

In other embodiments, video files that contain pre-rerecorded video can be fed into a frame preprocessing module. Video files can be stored either locally (e.g., on local storage) or remotely (e.g., on remote storage, on a server, cloud storage, or the like). This allows embodiments of the inventive subject matter to handle not only live video, but also recorded video to assist with, e.g., forensic analysis of video content.

In some embodiments, video streams from networked cameras can be fed directly into a frame preprocessing module. Directly feeding a video stream refers to passing video that is sent over a network connecting to a frame preprocessing module instead of having the video stream pass through a server or cloud, first. This can mean that a video stream is transmitted via local area network or that it passes over an internet connection in a way that it does not route through, e.g., any kind of third-party service (outside of ordinary network traffic routing).

In some embodiments, edge or USB cameras can generate video that is passed into a frame preprocessing module. These types of cameras can be configured for mobility and thus may generate video streams that need to be transmitted to different machines for processing.

In any event, a wide variety of video sources can transmit video to a frame preprocessing module of the inventive subject matter. Frame preprocessing modules can operate on a local or remote/cloud machines, or any other type of computing device configured to receive video content and that is capable of carrying out frame preprocessing tasks described in this application.

Frame preprocessing modules of the inventive subject matter are responsible for preparing video frames for processing by, e.g., computer vision models (which are incorporated into the scene understanding module described below). Frame preprocessing modules ensure that, e.g., key frames are optimized and tailored for scene understanding modules of the inventive subject matter, enhancing both computational efficiency and model accuracy. Key functions of frame preprocessing modules include decoding video streams, key frame selection, and preprocessing tasks (e.g., resizing, cropping, and so on).

Thus, according to FIG. 2, video content is passed from a video source to a frame preprocessing module. A module is a process or set of processes that exists in software, where that software can be run either locally (e.g., on a personal computer, smart device, or the like) or remotely (e.g., on a server, a set of servers, a cloud server, or the like). Video content and videos comprise scenes, such that the terms video and video content refer to any kind of video (e.g., live, pre-recorded, or any other format of video) while the term scene refers to some activity captured in a video or video content (e.g., a portion of some security camera footage, a news broadcast, home videos, YouTube videos, and so on). Videos can comprise multiple scenes, and scenes can overlap with other scenes.

FIG. 3 shows a schematic of a frame preprocessing module of the inventive subject matter. The frame preprocessing module described in this schematic is configured to, e.g., detect and remove noise and to correct deficiencies in frame/video-streams that would otherwise significantly diminish the capabilities of a video-based AI implementation's accuracy. The frame preprocessor can operate on both video streams and still images (e.g., key frames). The frame preprocessor is especially adept at handling low light, over-exposure, blurriness, strong backlights, and so on, by using both pixel-based algorithms as well as localized artificial intelligence algorithms.

Localized techniques described in this application can operate on one or more portions of an image, though the portion of an image that a localized technique applies to can include the entirety of an image such as a key frame. Determining how to apply a localized technique can involve identifying, using an AI model or algorithm, a localized portion of an image where a localized technique should be applied (e.g., identifying a part of an image that is overexposed so that a localized overexposure technique can be applied to correct that portion of the image).

The schematic in FIG. 3 is made up of blocks that contribute to its different functions of a frame preprocessor, which is broken into a vision pipeline and a vision correction pipeline. The actions of these blocks are not necessarily executed sequentially. Blocks 300-306 exist within a vision pipeline and blocks 308-330 exist within a vision correction pipeline. Block 300 is where the frame pre-processor receives streams of video content from, e.g., a set of cameras. The frame preprocessing module thus has several functions, including decoding, frame selecting, and pre-processing of selected frames. Pre-processing can be implemented to optimize frames (e.g., key frames) for improved computational efficiency and model accuracy. All digital video content is encoded or compressed in some way, and video decoding is the process of converting an encoded or compressed video stream into a format that can be displayed on a screen or can be subject to further processing. Thus, block 300 shows that video content is transmitted from video content sources and received within the vision pipeline portion of the frame preprocessor. Once received, the decoding manager takes over in block 302.

When a frame preprocessing module receives video from, e.g., a video management system (VMS), from network-based cameras, from video files, from USB/edge device cameras, or the like, the video is encoded in some manner. Videos are often encoded using compression algorithms to reduce storage and bandwidth requirements, which must be decoded into raw frames to make further processing possible. Video sources of the inventive subject matter are modeled in FIG. 3 as a set of cameras with one separated by an ellipsis to indicate there is no requirement for number of video sources. Many different video sources and video types can be accommodated by frame preprocessing modules of the inventive subject matter as described throughout this application.

Once video has been received, decoding manager in block 302 takes over. Decoding manager 302 can use hardware or software to uncompress (i.e., decode) video and audio streams. Video passed to the frame preprocessing module can exist in a compressed format to facilitate transmission over network connections, and the frame preprocessing module can thus decode incoming video to bring it into a format that can be used by the scene understanding module.

Some common codecs include H.264/AVC (Advanced Video Coding), H.265/HEVC, MPEG-4, and MJPEG. H.264/AVC is widely used in surveillance, streaming, and storage systems. H.265/HEVC (High Efficiency Video Coding) is an advanced codec offering high compression efficiency. MPEG-4 is commonly used in multimedia applications. MJPEG (motion JPEG) is often used in video surveillance for simplicity and compatibility. Frame preprocessing modules of the inventive subject matter can be configured to handle a wide variety encoded videos, where decoding capabilities are limited only by processing power. Frame preprocessing modules should be able to handle different bitrates and frame rates in different video streams, and they should be capable of efficiently managing resource usage (e.g., hardware and software resources) to ensure decoding occurs in real time.

Once video is decoded, it is handled by a buffer manager according to block 304. A buffer manager handles image buffers, which are regions of memory dedicated to video hardware. Image buffers store uncompressed video images and must be shared between different components that process these images in various ways. A buffer management plan can be useful in ensuring efficient video processing and smooth video playback.

Buffer management can be conducted in a variety of ways. A common method of image buffering involves using a global pool of image buffers, which can be allocated at startup or as needed. Image sources obtain unused buffers from this pool, fill them with data, and then pass the buffer pointers to the next component in the workflow. This next component can either pass the pointer along further or return the buffer to the pool. This approach enhances efficiency by minimizing unnecessary copying of uncompressed image data.

The frame preprocessing module also carries out frame selecting. Key frame selection can first occur in block 306 as carried out by the multi-stream manager. The multi-stream manager is tasked with handling video content from multiple sources, and it must facilitate frame pre-processing by selecting frames for pre-processing in the Vision Correction Pipeline. In video surveillance, for example, frame selecting is a process by which key frames from a video stream are identified and sometimes extracted (e.g., to create a scene, as described below). This process helps in summarizing video content. In some embodiments, key frames represent and are identified according to significant changes or events in a video, while in other embodiments keyframes are selected at regular intervals, at random, by clustering procedures, or according to another selection scheme. Key frames can be used by embodiments of the inventive subject matter to, e.g., summarize surveillance videos by detecting multiple change points and segmenting the video into scenes to create concise and informative summaries video content.

Different types of video content can necessitate different key frame selection techniques. Key frames can be selected based on activities that occur in a video, based on the speed that objects in a video move, or both. If a video is “high activity” that means there are multiple objects moving in the video. An object refers to anything that can be shown in a video. An object can be, for example, a person, an appliance, a tool, an animal, a vehicle and so on. Realistically, anything in a video can be an object or be thought of as an object, and whether something is interpreted as an object can be subject to AI model interpretation. For example, objects that should be identified in a video can be domain specific, and an AI model charged with identifying objects can be trained to identify only objects in that domain (e.g., an AI model could be trained to see motor vehicles for traffic monitoring).

High activity videos are videos where many objects are moving in the video (e.g., 2 or more, 5 or more, 10 or more, or any value therebetween). An example of a high activity video is a video from a traffic camera overlooking a bus freeway. Low activity videos are videos where a small number of objects are moving in the scene (e.g., less than 4, less than 6, less than 11 or any value therebetween). An example of a low activity video is a video from a parking lot camera. Videos with no activity are those in which no objects move. An example of a no activity video is a video from a parking lot camera at night.

Speed that objects in video move can also impact key frame selection. A high-speed video is one in which objects in the video are moving quickly (e.g., a highway camera). A low-speed video is one in which objects in the video are moving a low speed (e.g., a mall camera). And a no-speed video in one in which all objects are stationary (e.g., a mall camera at night).

Object speed can be estimated using techniques that go beyond simple pixel displacement to achieve real-world accuracy. One advanced method involves mapping positions in image space (i.e., pixel coordinates) to real-world distances by employing a calibrated perspective transform. By calibrating a camera's perspective, a system is able to convert spatial changes in a video frame into real-world units, such as meters per second or kilometers per hour. This contrasts with a basic approach where speed is calculated in terms of pixels per unit of time (e.g., pixels per hour), which does not provide meaningful real-world measurements.

A calibrated perspective transform establishes a relationship between a pixel layout in an image and an actual physical scale of the observed scene. This allows the system to account for depth and perspective, resulting in more accurate speed measurements. For example, objects closer to the camera might appear larger, while those farther away appear smaller, even if they are the same size in reality. The transformation corrects for these distortions, enabling the estimation of object speed as it moves across the frame.

Unlike naive approaches based solely on pixel displacement, which measure changes in pixel positions over time, a calibrated perspective transform integrates real-world dimensions into the calculation. This ensures that speed estimations are meaningful and can be directly interpreted in practical scenarios, such as traffic monitoring or sports analytics.

A frame rate of a video also plays a crucial role in determining object speed. Higher frame rates reduce the displacement of objects between consecutive frames, leading to smoother tracking and more precise speed measurements. For slow to medium-speed objects, a minimum frame rate of 10-15 FPS is generally recommended. High-speed objects, such as vehicles on a highway, require a minimum frame rate of 15-20 FPS to ensure accuracy.

By combining calibrated perspective transforms with high frame-rate video and advanced tracking algorithms, computer vision systems can efficiently and accurately determine object speeds in a wide range of applications, from traffic systems to surveillance footage analysis.

Different artificial intelligence models and other preprocessing techniques that may be applied to key frames can require different frame rates to function properly. For example, for a model to carry out object detection, there is no strict frame rate requirement, but it is preferred that a minimum frame rate of 10-15 FPS should be used for slow and medium-speed objects, while a minimum frame rate of 15-20 FPS should be used for high-speed objects. Thus, key frames should be selected at a key frame sampling rate of at least 10-15 FPS for slow/medium-speed objects or 15-20 FPS for high-speed objects.

Object tracking is carried out by monitoring how bounding boxes that surround objects move between frames, and it works best when movements of those bounding boxes between frames is minimal, implying higher frame rates work better than lower frame rates. Slow to medium-speed objects are best tracked when an input video has a minimum frame rate of 10-15 FPS, while high-speed objects can require a minimum frame rate of 15-20 FPS.

Object classification has no strict frame rate requirement, and best practices require classification to be performed over multiple frames or cropped images, with those results being averaged instead of relying on just a single result. For example, once a moving vehicle is detected, its type (e.g., car, bus, SUV, etc.) can then be classified across successive frames to enhance accuracy.

Object detection and object tracking models should run both when objects in a video are moving and also when no movement is detected, to detect both moving and stationary objects that may be present. To be effective, when objects are moving, a higher frame rate can be required to accurately track moving objects, because object trackers perform best when the displacement between successive frames is minimal.

Pose estimation, which is a computer vision technique that identifies and tracks the position and orientation of a person or object in an image or video, has no strict FPS requirement. Similar to object classification, pose estimation is carried out on a frame-by-frame basis to determine a person or object's pose within each frame individually.

Applying a CLIP model requires, in general, as low as a 1 FPS input. But because some rapid changes can occur between frames when a very low frame rate like 1 FPS is used (e.g., a person turns their head), a minimum of 2-5 FPS is recommended. CLIP models, as described throughout this application, can be used to encode images for text-based image retrieval. CLIP models can be run when motion is detected in a frame to capture changing scene contexts. To do this, a minimum framerate of 1-5 FPS is ideal. When objects in a video are stationary or there is otherwise no motion detected, 1 FPS or lower can be sufficient. For example, in an empty parking lot without any motion, analyzing frames at 1 FPS can be enough.

VLLMs require a minimum input frame rate of, in general, between 1-4 FPS when objects are moving at high speed. When no objects in a video are moving, the frame rate can be even lower, down to 1 FPS or below. VLLMs can run when motion is detected in a video. When motion is detected, a VLLM is fed frames as described above to form batches of 8-64 frames for processing. This approach balances efficient processing with contextual understanding, avoiding resource-heavy operations when a video does not feature any significant changes.

Other models, such as segmentation, OCR, depth estimation, and so on, can all have distinct frame rate requirements or minimums. A minimum frame rate required for a specific model can depend on the task the model is charged with carrying out (e.g., higher frame rates are required where a model requires more visual information per second to carry out its task).

For example, in a video comprising a fight, a model trained to recognize fighting only needs to run when motion is detected in a video, since fighting cannot occur in the absence of movement. Running the model when there is no motion would be inefficient and unnecessary.

In another example, an illegal parking detection model that is configured to detect vehicles should only run when vehicle motion is detected and it should keep running until the vehicle it has detected leaves the frame within an allowable time limit (e.g., corresponding to a parking time restriction).

Motion estimation uses motion information in compressed videos to minimize data redundancies between consecutive frames. This is achieved through encoding motion vectors and residual data. Motion vectors indicate a displacement of a block of pixels from one frame to the next, and residual data represents the difference between predicted motion and actual content. Video codecs like H.264, H.265, and VP9 use this technique for efficient compression, especially when a background remains static while objects are moving. CCTV systems can use motion vectors from compressed video streams to detect movement, avoiding pixel-by-pixel analysis. This saves processing time and power, making it ideal for real-time use.

Motion estimation confers several advantages. It has low computational requirements and does not need pixel-level analysis because motion vectors are inherently part of the video stream. It is capable of efficient vector extraction, which enables real-time detection. It has low latency, which is ideal for surveillance where quick responses can be crucial. And it can be seamlessly integrated as motion data is embedded within a video stream, which eliminates a need for separate image processing.

Drawbacks include a risk of false positives and the introduction of noise and compression artifacts. Additionally, minor environmental changes (e.g., flickering lights) can mistakenly trigger motion alerts. Motion vectors are optimized for compression rather than precise motion tracking, which can result in small or subtle movements being missed.

In instances where motion information is not directly available (as with, e.g., codecs that lack motion vectors) optical flow techniques can be used to estimate motion by analyzing changes in the pixel intensity between frames. Unlike codec-based motion vectors, optical flow techniques calculate apparent motion of objects directly, capturing finer and more accurate movements.

Optical flow techniques benefit from brightness consistency, spacial coherence, and temporal smoothness. Thus, an object that is tracked via optical flow should have a largely constant brightness from one frame to the next, neighboring pixels in an object should typically move in a similar way, and movements between frames should occur gradually.

Several optical flow techniques can be implemented, including pixel-based methods, block-based methods, and neural network-based methods. Pixel-based methods calculate motion at the pixel level, block-based methods divide a frame into blocks and then estimate motion for each block, and neural network-based methods (such as NeuFlow v2) generate a dense motion field by estimating motion for each pixel.

Pixel-based optical flow techniques estimate motion by analyzing changes in pixel intensity across consecutive video frames. A notable example is the Lucas-Kanade algorithm, which assumes small pixel displacements and relies on brightness consistency, spatial coherence, and gradual temporal changes. This method involves selecting a small pixel window, calculating spatial and temporal gradients, and solving optical flow equations using least-squares fitting to derive motion vectors. The process is repeated for all pixels, creating a dense optical flow field that captures motion across the frame.

Lucas-Kanade is widely used in video stabilization, object tracking, motion analysis, and robotic navigation due to its precision and efficiency. While effective, it assumes minimal movement between frames and can be sensitive to noise or brightness variations. Despite these limitations, its pixel-level accuracy makes it a cornerstone for real-time and detailed motion tracking applications.

Block-based optical flow methods are techniques used to estimate motion in video by dividing each frame into smaller, fixed-size blocks and analyzing the movement of these blocks between consecutive frames. Unlike pixel-based methods, which calculate motion at the individual pixel level, block-based methods focus on groups of pixels within each block, making the process computationally more efficient. Each block is treated as a single unit, and the motion estimation is performed to determine the displacement of the block from one frame to the next. This displacement is calculated by searching for the best match of the block in adjacent frames using metrics such as sum of squared differences (SSD) or normalized cross-correlation. The result is a motion vector that represents the movement of the block. These methods are particularly useful for applications requiring moderate precision, such as object tracking in video surveillance or low-resolution video analysis.

Advantages of block-based optical flow methods include reduced computational demands compared to pixel-based techniques and their ability to handle larger-scale motion effectively. Since each block encompasses multiple pixels, the approach is less sensitive to noise or small variations in brightness, which can affect pixel-level methods. But block-based methods come with limitations. Their accuracy depends on the size of the blocks; larger blocks may overlook finer details of motion, while smaller blocks may increase computational complexity. They can also struggle to track subtle or irregular movements within a block, as the method assumes a uniform motion for all pixels in the block. Despite these drawbacks, block-based optical flow remains an excellent tool for scenarios where a balance between computational efficiency and motion estimation accuracy is needed.

Neural network-based optical flow techniques leverage advanced machine learning models to derive motion estimations with high precision and robustness. These methods use deep convolutional neural networks (CNNs) or other specialized architectures to analyze video frames and create dense motion fields that capture the movement of objects within scenes. Unlike traditional pixel-based or block-based approaches, neural network methods use learned features from large datasets to understand complex patterns of motion. By training on diverse scenarios, these networks are equipped to handle challenging frame conditions, such as varying light intensities, occlusions, or rapid movements. One notable example is the NeuFlow v2 model, which processes each pixel in a frame to construct a comprehensive representation of motion dynamics across an entire video. These techniques excel in applications like autonomous navigation, human activity recognition, and video analytics, where precision and scalability are paramount.

Advantages of neural network-based optical flow methods stem from their ability to generalize across a wide range of conditions, making them less susceptible to noise and artifacts compared to conventional techniques. They can identify subtle motions and adapt to varying video resolutions. But they require significant computational resources and extensive training data to achieve optimal performance, which can be challenging for real-time implementations or resource-constrained devices. These methods also demand robust preprocessing steps, such as resizing and cropping frames, to align with model requirements and ensure accurate predictions. Despite these demands, their capacity to capture intricate motion details establishes neural network-based optical flow techniques as a valuable tool in cutting-edge video processing tasks.

Systems and methods of the inventive subject matter can also implement change detection techniques. Change detection techniques identify differences between consecutive images or video frames, which can be useful for, e.g., surveillance, traffic monitoring, and environmental analysis. These techniques highlight changes like moving objects or scene modifications without specifying a direction of motion. Output generated by these techniques typically includes a binary or grayscale mask indicating the changed areas.

Change detection techniques can include, e.g., frame differencing, temporal averaging, background subtraction, moving-median method, and optical flow for change detection, among others. Frame differencing is a straightforward and widely used technique for change detection in video analysis. It involves subtracting pixel values of consecutive video frames to identify regions where motion or changes have occurred. The result of this subtraction is often a binary or grayscale mask that highlights the areas exhibiting differences, effectively isolating moving objects or scene alterations. Frame differencing is valued for its simplicity and computational efficiency, making it suitable for real-time applications. But frame differencing is sensitive to noise, variations in lighting, and camera jitter, which can lead to false positives or missed detections. Despite these limitations, it remains a practical approach for scenarios with stable conditions and moderate computational resources.

Temporal averaging is a change detection technique that compares pixel values of a current video frame against average pixel values of previous frames. By smoothing out random fluctuations and noise, it provides a clearer distinction between stationary and moving elements in a scene. This approach is particularly effective in scenarios where gradual or repetitive changes need to be identified, such as detecting slow-moving objects or subtle scene alterations. But this technique can struggle with abrupt or rapid movements, as the averaging process can obscure the immediate intensity of such changes. Temporal averaging is often used in conjunction with other methods to balance noise reduction with responsiveness to dynamic activity.

Background subtraction is a change detection technique that maintains a reference model of a scene to identify changes by comparing each video frame against this model. It is particularly effective in detecting moving objects or scene alterations by isolating them from the static background. Variants of this technique, such as the Gaussian Mixture Model (GMM), excel at handling dynamic backgrounds by accommodating variations in pixel values, while Kernel Density Estimation (KDE) models pixel value distributions to cope with complex background changes. This method is widely used in applications like surveillance and traffic monitoring, as it provides a clear distinction between foreground and background, though its performance can be influenced by lighting changes, noise, and camera motion.

The moving-median method for change detection involves computing the median of pixel values over a series of video frames. This approach is effective at reducing noise and managing gradual changes, such as shadows, which can complicate other techniques. But this method comes with the drawback of being computationally demanding, particularly when applied to long video sequences. Despite its challenges, the moving-median method is valuable in scenarios where precision in handling subtle changes outweighs a need for computational efficiency.

Optical flow techniques, while primarily designed for motion estimation, can effectively detect changes by modeling the background and identifying differences in motion patterns between video frames. These methods generate dense motion fields capturing pixel-level or block-level movements, enabling the segregation of moving objects from stationary elements within a scene. By strategically applying optical flow, changes such as object displacement, scene alterations, or dynamic activity can be highlighted without requiring explicit directional motion. This makes optical flow a powerful tool for applications in surveillance, traffic monitoring, and environmental analysis, where precise identification of changes is crucial.

Not all frames of a decoded video may be relevant to a scene understanding module, and not all frames that are decoded—as discussed above in more detail-are needed for each different technique that may be applied to those frames. Thus, selecting frames judiciously is critical to balance computational efficiency and task accuracy. Frame rates of incoming video can be high (e.g., 30+ FPS) or low (e.g., less than 30, though generally in the range of 5-10 FPS). High frame rates can be necessary for, e.g., computer vision models that track dynamic or rapidly changing objects—such as a vehicle detection model—where object locations can change significantly between frames. Lower frame rates can be suitable for, e.g., computer vision models that analyze relatively static attributes and objects, such as a vehicle color classifier, where color information remains relatively constant over time. Key frame selection can be adjusted depending on video frame rate as well as expected content in a video (e.g., if high speed movements are expected, more key frames may be selected to ensure those movements are adequately captured in the selected key frames).

A variety of frame selection techniques can be implemented, including uniform sampling and dynamic sampling. With uniform sampling, the frame preprocessing module selects frames at fixed intervals. With dynamic sampling, the frame preprocessing module selects frames at variable intervals, where the selection rate can be adjusted according to requirements of, e.g., a computer vision model deployed in a scene understanding module, other aspects of the scene understanding module, content of the video that key frames are being selected from, and so on.

With uniform sampling, key frames are selected such that the selected key frames result in a key frame sampling rate (measured in frames per second or FPS) when played as a video. Thus if a key frame sampling rate is 10 FPS, that means that regardless of the natural framerate of a video, key frames selected from the video are selected at a rate of 10 FPS. Time domain information for selected key frames can be preserved so that key frames can be played back as a video A resulting key frame sampling rate is thus configured manually and remains constant, regardless of activity levels or object speeds in a given video. Manual key frame sampling rate adjustments can be introduced by a human user based on expected activity levels and expected object speeds.

For videos that capture minimal movement or slow-moving objects (e.g., hallways, parking lots), key frame sampling rates of at least 12-15 FPS are typically sufficient. For videos that capture high activity or high-speed object movements (e.g., retail stores, busy intersections), maintaining a minimum key frame sampling rate of 20-30 FPS can be essential to ensure all moving objects are adequately captured for frame preprocessing.

In contrast to static rate key frame selection, adaptive key frame selection techniques dynamically modify a rate at which key frames are selected according to activity levels and object speeds in a video or scene. Adaptive key frame selection techniques ensure that higher key frame sampling rates result during portions of a video that require it (high object speed, high activity, or both) and that lower key frame sampling rates result during portions of a video that do not (low activity, low object speed, or both).

Adaptive frame selection can be carried out by a variety of different techniques, including change detection using background subtraction and motion estimation using optical flow or motion vectors.

Background subtraction is widely used in surveillance to detect motion by modeling a static background and comparing each new frame to this model. When minimal changes are detected in a video (indicating a low activity or low object speed), the key frame sampling rate can be reduced to 12-15 FPS. And when significant changes occur in a video (e.g., a person enters an empty room), the key frame sampling rate is immediately increased to 20-30 FPS. This technique is effective for environments where motion is sporadic, as it ensures critical incidents are recorded with enough clarity that details or activities are not missed.

Motion estimation using optical flow or motion vectors can also be used. For example, an optical flow technique can calculate pixel displacement between consecutive frames to detect gradual or subtle motion. Motion vectors from a compressed video (e.g., CCTV systems often use compression formats like H.264 and H.265, which feature motion vectors) can indicate pixel block movement and can be directly used to gauge scene motion without additional computations. When significant motion is detected in a video according to the video's motion vectors (e.g., fast-moving vehicles), the key frame sampling rate is increased to ensure accurate object tracking. When minimal motion is detected, a key frame sampling rate can be reduced to save resources (e.g., computational resources). Optical flow techniques can be suitable when abundant computational resources are available, and motion vector techniques can be more practical for e.g., edge devices due to relatively lower computational demands.

Key frame selection can also be carried out in consideration of domain specific models that may exist in any of Tiers 1, 2, or 3 of a scene understanding module that key frames are sent to after preprocessing. In one example, a camera captures video from a seaport, and a system of the inventive subject matter is tasked with monitoring activities in the seaport. Accordingly, the system is required to: count how many people are working with machinery, detect if a person is working without PPE or a safety harness, count a number of heavy vehicles, and check for the presence of a supervisor (which is identifiable by a white helmet).

In this example, the presence of one or more heavy vehicles/machinery acts as a primary trigger. If heavy machinery is detected, then person counting is activated, PPE detection is activated, safety harness detection is activated, and helmet color classification is activated. If no heavy machinery is detected, then a lower key frame sampling rate is required. Thus, the key frame sampling rate is lowered and object detection and classification techniques are not applied to conserve resources.

To maximize efficiency and accuracy in video analysis, change detection, motion estimation, and domain-specific requirements can all be integrated into a unified frame selection framework. An integrated approach combines static, adaptive, and domain-specific strategies. An example of an integrated approach features an initial frame rate configuration, a change detection trigger, a motion estimation adjustment, and a domain-specific logic layer. The initial frame rate configuration defines a baseline key frame sampling rate (e.g., a minimum of 12-15 FPS for static areas, or a minimum of 20-30 FPS for dynamic zones). A change detection trigger can continuously monitor a scene for significant changes using background subtraction, and it can increase a key frame sampling rate temporarily when a change is detected (e.g., a person enters a quiet area). Motion estimation adjustment techniques then use optical flow or motion vectors to assess motion intensity. For example, gradual or continuous motion can trigger an increase in a key frame sampling rate. And finally, in a domain-specific layer, additional context-specific logic can be applied based on a targeted application. In the seaport example, the presence of heavy machinery can be detected before activating human detection and safety checks, because in the absence of heavy machinery, the presence of people is irrelevant as there is no heavy machinery there to injure them. This integrated approach thus balances efficient processing with accurate event capture, thereby reducing computational loads without compromising on detecting critical incidents.

Clustering methods can also be implemented to give rise to intelligent frame selection. Algorithms like K-means, DBSCAN, and other hierarchical clustering techniques can be used to group similar frames based on features such as color histograms, edge patterns, or deep feature embeddings. Representative frames from each cluster are then selected as key frames to ensure diversity in key frames while minimizing redundancy. This approach can be useful for summarization tasks or when processing long, unchanging scenes, as it prioritizes capturing key variations without unnecessary duplication.

Key frames that the frame preprocessing module identifies correspond to scenes in videos. Key frames are representative of scenes. In some embodiments, a set of key frames corresponds to a scene that comprises multiple frames around each key frame in the set of key frames or that is bounded by the keyframes (e.g., a scene can be a segment of a video that starts at a first key frame in a set and ends with a last key frame in a set), and in some embodiments a set of key frames that are selected make up a scene. For example, if a scene is 350 frames long, then the set of key frames can have 350 frames. In some embodiments, key frames the frame preprocessing module identifies can be some subset of the total frames making up a scene (e.g., such the key frames making up a scene can playback the scene at a lower frame rate than the video the scene came from would ordinarily playback at).

Key frame selection is an important aspect of embodiments of the inventive subject matter. As described in this application, the selection of key frames can depend on the activity level and the speed of objects in the video. High activity or high-speed objects may require a higher frame rate to ensure that all significant movements are captured, while low activity or slow-moving objects can be adequately captured with a lower frame rate. Different video analysis tasks may have specific frame rate requirements. For example, object detection and tracking generally require higher frame rates to accurately capture moving objects, while tasks like object classification and pose estimation may not have strict frame rate requirements. Adaptive techniques can dynamically adjust a key frame sampling rate based on the content of a video. For instance, background subtraction can be used to detect motion and adjust the frame rate, accordingly, increasing it during high activity periods and decreasing it during low activity periods. Selecting key frames can also be influenced by the specific requirements of the domain of a video. For example, in a seaport monitoring system, the presence of heavy machinery might trigger higher frame rates and additional object detection tasks. Efficient key frame selection is essential to balance computational resources and task accuracy. Techniques like uniform sampling and dynamic sampling can be used to optimize the selection process. Finally, once key frames are selected, they may undergo various preprocessing techniques to enhance their quality and ensure they meet requirements of a scene understanding module. This can include resizing, cropping, and low-light enhancement, among a cadre of other corrections and preprocessing techniques. Effective key frame selection optimizes both the accuracy and efficiency of video analysis tasks that follow in a scene understanding module.

In some embodiments, key frames can be passed to the scene understanding module as they are extracted from a video (e.g., key frames are streamed in real time as they are selected), and whether a set of key frames makes up a scene (and what key frames should be in that set) can be determined after processing by the scene understanding module has taken place. This can be true in circumstances where characteristics that define a scene cannot be known until after key frames have been fully processed and understood. For example, it may be useful to create a scene from a video where the scene includes every key frame where a scene is one in which a red ball appears, and that information cannot be known until the key frames are fully processed and the “scene” has been understood—then it can be identified as a scene. How quickly key frames can be passed to (or streamed to) a scene understanding module from a frame preprocessing module can depend on available processing power—more processing power facilitates faster key frame selection and faster key frame processing. The scene understanding module carries out its processing tasks in real time or near real time (and subject to some latency) as preprocessed key frames are streamed to it from the frame preprocessing module.

Thus, because embodiments of the inventive subject matter operate in real time, key frames can be sent from the frame preprocessing module on an individual basis as a video is received by a frame preprocessing module. Because in most circumstances, key frames selected by the frame preprocessing module are a subset of total frames in a video, the scene understanding module can then receive each key frame and carry out its scene understanding tasks (as discussed below) without processing slowdown that may occur if every single frame from a video is sent to the scene understanding module. Thus, when describing a “set of key frames” as being transmitted to the scene understanding module, it should be understood that this process can occur over a period of time where each key frame in the set is sent to the scene understanding module for further processing sequentially.

After the frame preprocessing module using, e.g., multi-stream manager 306 selects frames (e.g., as each key frame is selected, preprocessing can be carried out in real time), each selected key frame can undergo additional preprocessing in the Vision Correction Pipeline to align with specific requirements of a scene understanding module (e.g., requirements of computer vision models incorporated into a scene understanding module).

To determine what preprocessing techniques should be applied to each key frame, runtime insights can be collected at the time of key frame selection. Runtime insights play a role in optimizing the preprocessing of video content, particularly in real-time applications. Runtime insights are collected dynamically during the process of key frame selection and enable adaptive adjustments to accommodate specific requirements of the scene understanding module. For instance, runtime insights can identify challenges such as low light conditions, lens distortion, or regions of interest that need to be focused on. Based on these observations, preprocessing techniques such as resizing, cropping, low-light enhancement, and lens distortion correction can be applied to ensure that the key frames are tailored for seamless integration into the downstream tasks of computer vision models. Such adaptability improves the module's ability to handle diverse conditions and scenarios, whether it involves surveillance footage, industrial monitoring, or other domain-specific applications.

Furthermore, runtime insights enhance the efficiency and accuracy of video analysis by facilitating intelligent decision-making tailored to the input's characteristics. For example, when runtime insights detect minimal motion or static scenes, computational resources can be conserved by reducing the frequency of key frame selection. Conversely, in dynamic scenarios where significant activity is detected, runtime data can trigger higher key frame sampling rates and activate advanced preprocessing modules to capture critical events with higher fidelity. Additionally, these insights aid in determining the applicability of specialized correction techniques, such as de-raining, sharpening, or super-resolution, depending on the observed issues in the video content. By leveraging runtime insights, frame preprocessing becomes a highly adaptive and resource-efficient process, ensuring optimal conditions for the accurate interpretation of visual data by scene understanding modules.

Key frames are first received by the video correction and enhancement orchestrator in block 308. Video correction and enhancement orchestrator 308 can be responsible for some initial frame pre-processing, including resizing, cropping, low-light enhancing, and other model-specific preprocessing (e.g., preprocessing that accounts for aspects of a scene understanding module that will process the key frames). Resizing can be used to adjust frame dimensions to match an input size that a scene understanding module expects (e.g., resizing to 224×224 pixels for classification models such as ResNet). Cropping can be used to extract or limit a frame to specific regions of interest (ROIs) to eliminate irrelevant information so that a target area can be focused on by a scene understanding module. Low-light enhancing involves altering frames captured in poor light conditions to improve scene understanding module performance (e.g., computer vision model performance) in low-visibility scenarios.

In some embodiments, video content that is received at video correction and enhancement orchestrator 308 and decoded is subject to warping resulting from the type of lens used when the video is recorded. For example, if a fish-eye lens is used to record video, the video content recorded can be warped, which can make it more difficult for a computer vision model to identify things in the image. Frame preprocessing modules of the inventive subject matter can thus “unwarp” image content of key frames to make them easier to interpret.

Some common tools to unwarp fisheye video content include Adobe After Effects, DaVinci Resolve, and OpenCV. With Adobe After Effects, a built-in VR-converter tool can be used to unwarp fisheye video. The steps include cropping the circular video into a square shape, creating a new composition with the desired VR size, applying the VR converter effect, and setting the input to fisheye with the appropriate field of view.

With DaVinci Resolve, a lens correction option or the lens distort tool can be used to correct fisheye warping. Adjusting distortion and anamorphic squeeze parameters can help straighten lines and reduce distortion. And OpenCV is a free image processing library that can be used to remove fisheye lens distortion from any video footage taken in wide view mode. The process involves camera calibration and adjusting settings for optimal results.

Lens distortion correction can also be carried out by the frame preprocessing module. Lens distortion correction addresses various types of lens-related warping, such as barrel or pincushion distortion, that cause straight lines to appear curved in video footage. There are two primary causes of barrel distortion: the inherent optical design of wide-angle lenses, and imperfections or aberrations in a lens's glass or construction. Wide-angle lenses are designed to capture a much wider field of view compared to standard lenses. The physics involved with refracting such a wide angle of incoming light leads to visual distortions, including the signature outward curving associated with barrel distortion. Imperfections or aberrations in a lens's glass or construction can worsen the effect. Elements within a lens that are improperly shaped or aligned, as well as low-quality or imprecise glass, may introduce additional distortions, causing increased curving and stretching along the edges.

Pincushion distortion is the opposite of barrel distortion. It causes straight lines to curve inward from the edges to the middle. Telephoto and telephoto-zoom lenses are most commonly associated with pincushion distortion.

Lens distortion correction techniques typically use geometric transformations to compensate for a lens's curvature, restoring the image to its natural proportions. These techniques are particularly useful for wide-angle and CCTV cameras, which often introduce such distortions, ensuring the footage appears more accurate and visually correct. Correction for lens distortions can make it much easier for models of the inventive subject matter to interpret the visual content in key frames, improving accuracy and efficiency.

Video correction and enhancement orchestrator is also responsible for determining which of the different video correcting blocks should be implemented for a particular key frame or set of key frames. Video correcting blocks include de-noising block 310, de-blurring block 312, over/under exposure correction block 314, backlight correction block 316, de-raining block 318, and de-glaring block 320, sharpening and dehazing block 322, super-resolution block 324, low-light enhancement block 326, and reflection removal block 328. Other preprocessing techniques can also be carried out even if they are not explicitly described with a corresponding block.

In some embodiments, video correction and enhancement orchestrator 308 can also perform edge detection. For example, edge enhancement can be applied to frames to improve performance of a scene understanding module that receives those frames. Color space conversion can also improve scene understanding module performance. By converting all or portions of key frames to alternative color spaces like HSV (hue, saturation, and value), HSL (hue, saturation, and lightness), or grayscale, scene understanding modules of the inventive subject matter can operate more efficiently depending on the tasks undertaken.

In some embodiments, frame preprocessing modules of the inventive subject matter can carry out noise removal on key frames, including motion de-blurring, deraining, dehazing, and deglaring. De-noising can be carried out by de-noising block 310. De-noising can be localized in key frames it is applied to. Block 310 is thus employed to mitigate or eliminate visual noise, such as grain or static, that can appear in camera footage, particularly under low-light conditions. This noise can obscure details and diminish the overall quality of the image. De-noising algorithms function by smoothing out random variations in pixel values while preserving critical image details, thereby producing a cleaner and sharper video.

There are various techniques used for de-noising, including spatial filtering, frequency domain filtering, and machine learning methods. Spatial filtering techniques, such as Gaussian blur and median filters, work directly on the pixel values, averaging them to reduce noise. Frequency domain filtering involves transforming the image into the frequency domain using methods like the Fourier Transform, filtering out high-frequency noise components, and then transforming it back. Machine learning approaches, such as convolutional neural networks (CNNs), have shown impressive results by training models on large datasets to identify and remove noise while maintaining image quality. These advanced techniques leverage vast amounts of data and computational power to achieve superior de-noising performance.

In practical applications, de-noising is widely used in various fields such as medical imaging, where it helps improve the clarity of scans, and in astrophotography, where it aids in capturing clearer images of celestial objects. It also plays a crucial role in surveillance and security systems, enhancing the visibility of footage captured in low-light environments.

De-blurring can be carried out in block 312. Blur reduction addresses blurring that can occur when either a camera moves too quickly or objects within the frame are in rapid motion. This correction enhances clarity by using de-blurring techniques to minimize the appearance of blurred edges and moving objects. It is particularly useful in scenarios like high-speed traffic monitoring, where vehicles may appear blurred, or in footage captured by low-quality cameras with slower shutter speeds. Methods such as ‘Real-Time Video De-blurring via Lightweight Motion Compensation’ enable real-time de-blurring.

Motion de-blurring can be a crucial task in computer vision aimed at restoring images degraded by motion blur. Some common techniques used for motion de-blurring include using a Wiener filter, Convolutional Neural Networks, Generative Adversarial Networks (GANs), Recurrent Neural Networks (RNNs), and transformer networks. One or more of these techniques can be used on key frames that are subject to pre-processing.

A Wiener filter is a classic de-blurring technique that uses a restoration filter to reduce noise and blur. It requires knowledge of the Point Spread Function (PSF) and the signal-to-noise ratio (SNR) to synthesize an appropriate filter.

CNNs, RNNs, GANs, and transformer networks are all deep learning-based techniques. CNNs are widely used for image de-blurring due to their ability to learn spatial hierarchies of features. They can effectively capture local patterns and textures in images, making them suitable for de-blurring. This type of network is thus readily applied to key frames of the inventive subject matter.

Generative Adversarial Networks (GANs) generally have two simultaneously trained networks, a generator network and a discriminator network. The generator tries to create de-blurred images, while the discriminator attempts to distinguish between real and de-blurred images. This adversarial process helps in generating high-quality de-blurred images.

Recurrent Neural Networks (RNNs), and Long Short-Term Memory (LSTM) networks in particular, are used for sequential data processing. They can be applied to motion de-blurring by treating the de-blurring process as a sequence of steps, where each step refines the image further.

Transformer networks were originally designed for natural language processing and have been adapted for image processing tasks. They can capture long-range dependencies in images, making them effective for complex de-blurring tasks. Transformers use self-attention to highlight important image features, essential for effective de-blurring. Some methods operate in the frequency domain, using the convolution theorem to simplify computation. Image de-blurring transformers often follow an encoder-decoder structure, with self-attention refining details. A discriminative frequency domain-based feed-forward network (DFFN) can enhance performance by selectively preserving low-and high-frequency information.

Backlight correction block 316 can be used to fix issues with backlighting. Several techniques can be employed to address image contrast and lighting issues, including backlight issues. Histogram Equalization improves image contrast by redistributing intensity values, thereby enhancing details in darker regions. Adaptive Histogram Equalization, while similar, operates on small regions of the image rather than the entire image, offering superior local contrast enhancement. Gamma Correction modifies the luminance of an image; applying a gamma curve can brighten dark areas while minimally affecting brighter regions. Image Fusion combines images taken at various exposure levels, aiding in balancing lighting and revealing details in both bright and dark areas. Lastly, advanced techniques utilize AI models for automatic detection and correction of backlighting issues, as these models are trained to adjust lighting across diverse scenarios.

Some example AI models include Face26, Fotor, and Phot.ai. Face26 uses advanced AI technology to correct lighting issues, enhance brightness, and balance contrast automatically. It analyzes the photo to identify areas with uneven lighting and optimizes these areas to ensure a naturally lit photo without losing detail. Fotor can relight and brighten images to improve their overall quality. It detects content from images and automatically adjusts lighting and exposure, providing high-resolution results. And Phot.ai uses advanced AI Light Effect algorithms to analyze and adjust the contrast and fix lighting in photos. It automatically identifies areas that need improvement and enhances them for optimal results.

De-raining can be carried out in block 318. De-raining techniques are implemented to address visual noise caused by raindrops on a camera lens or the scene being captured. Raindrops can blur parts of the image and create distracting streaks, reducing visibility and clarity. The de-rain process involves using algorithms to identify and remove these raindrops from the footage, restoring the image to a clearer, more detailed state. It is in outdoor environments where weather conditions like rain can impact the quality of video streams.

De-raining can be carried out in ways similar to de-blurring. For example, de-raining can be carried out using CNN, GANs, RNNs, and transformer networks. More traditional techniques like image decomposition and filtering methods can also be used, as well as multi-level decomposition and frequency domain-based methods.

De-glaring can be carried out according to block 320. De-glaring is a technique used to reduce or eliminate glare caused by bright light sources, such as headlights, streetlights, or reflections on windows, which can obscure important details in a video. De-glaring typically involves adjusting an image by reducing an intensity of a light source and restoring visibility of objects that may have been washed out or hidden by the glare. This technique improves image clarity, especially in low-light or high-contrast situations, ensuring clearer surveillance footage.

Sharpening and de-hazing take place in block 322. Sharpening is a technique used to enhance the clarity and definition of an image by increasing the contrast of edges and fine details. This process works by accentuating the boundaries between different areas in the image, making objects appear crisper and more distinct. In CCTV footage, sharpening can help improve the visibility of key features, such as faces, license plates, or other important objects, particularly when the image is slightly blurred or lacks clarity. But over sharpening can introduce noise, so it can be important to sharpen an image judiciously for optimal results.

De-hazing techniques can be used to improve visibility and clarity of video footage affected by haze, fog, or mist. These atmospheric conditions can reduce contrast and make distant objects appear blurry or washed out. De-hazing enhances an image by adjusting contrast, brightness, and sharpness, making the scene appear clearer and more defined. It is usually used in outdoor surveillance, where weather conditions like fog or mist can obscure details in the footage.

Overexposure occurs when an image sensor is exposed to too much light, which can cause details to be lost in some areas (e.g., washed-out highlights). This results in a lack of detail in the brightest parts of an image. Underexposure happens when the image sensor does not receive enough light, causing details to be lost in shadows and making it hard to distinguish objects in low-light areas of an image. Over-and underexposure can be corrected by processing techniques carried out by block 314, which is tasked with over/underexposure correction. Block 314 can carry out exposure correction, including localized exposure correction.

Pre-processing of key frames can be carried out entirely or in part by, for example, MPRNet. In other words, the Vision Correction Pipeline can comprise an implementation of MPRNet, and thus each of the tasks described in relations to the blocks described within the Vision Correction Pipeline can be carried out by MPRNet. MPRNet is a state-of-the-art image restoration network that effectively balances spatial details and contextual information through its multi-stage architecture and adaptive attention mechanisms. It has shown impressive results in tasks like de-blurring, deraining, and denoising.

MPRNet is characterized by several key features that contribute to its effectiveness in image restoration. The multi-stage architecture of MPRNet progressively restores degraded images, enhancing quality through a step-by-step recovery process. Its per-pixel adaptive attention mechanism reweights local features with supervised attention to balance spatial details and contextual information effectively. MPRNet also facilitates two-faceted information exchange, where information is exchanged sequentially between stages and laterally between feature processing blocks to minimize information loss.

Frame preprocessing modules of the inventive subject matter can also be configured to carry out reflection removal in block 328. Reflection removal focuses on eliminating unwanted reflections from surfaces like glass or water that can obscure portions of a key frame. Traditional methods, such as image decomposition and gradient-based techniques, aim to separate the reflection from the scene but often face difficulties in complex situations. A key approach in this area is single-image reflection removal, which uses deep learning models to effectively distinguish between one or more reflected layers and one or more background layers in a single captured image (e.g., a key frame).

Techniques like DSRNet (Single Image Reflection Separation via Component Synergy) have been developed to tackle this challenge. DSRNet, or Dynamic Super-Resolution Network, is a convolutional neural network designed for image super-resolution. It aims to enhance the quality of images, particularly in complex scenes, by using a dynamic and heterogeneous architecture.

DSRNet features a number of blocks that contribute to its functionalities. A residual enhancement block facilitates hierarchical features to improve image quality by capturing and enhancing residual information. A wide enhancement block captures a wide range of features from the input image, handling various details and textures. A feature refinement block refines features extracted by previous blocks, aligning and optimizing them for final reconstruction. And lastly, a construction block reconstructs the high-resolution image by combining refined features to produce a high-quality output.

Frame preprocessing modules of the inventive subject matter can also be configured to conduct super-resolution imaging according to block 324. Super-resolution techniques involve increasing the resolution of an image or video to improve sharpness and detail. This is typically achieved by reconstructing a high-resolution output from a low-resolution input using machine learning models that are trained on large datasets to infer missing information. Traditional super resolution methods, such as bicubic interpolation and edge-preserving filters, estimate pixel values based on surrounding pixels. But these methods often result in blurry or unrealistic images due to their inability to capture fine details.

Deep learning-based super resolution methods, using models like GANs and CNNs, predict high-resolution outputs from low-resolution inputs by learning the underlying structures and patterns in high-quality data. Techniques such as ESRGAN (Enhanced Super-Resolution Generative Adversarial Network) and ESPCN (Efficient Sub-Pixel Convolutional Network), SAFM (Spatially-Adaptive Feature Modulation for Efficient Image Super-Resolution) have demonstrated significant improvements, producing sharper and more accurate results.

Super resolution has a broad range of practical applications. In facial recognition, it improves the identification of faces in low-resolution or distant images, which is important for security and surveillance. In license plate recognition, it enhances the clarity of vehicle license plates captured at a distance or in poor conditions.

Frame preprocessing modules can also conduct low-light enhancement on key frames according to block 326. Low-light enhancement improves images or videos captured in dim conditions. Traditional methods adjust pixel values using algorithms to increase brightness or contrast, such as histogram equalization and gamma correction. As a drawback, these approaches can sometimes result in unnatural colors and artifacts. Deep learning techniques, including Zero-DCE (Zero-Reference Deep Curve Estimation), yield superior results by learning enhancement curves directly from low-light images. These methods do not require paired images for training, which makes them more flexible and effective, particularly when data is scarce.

Any of the pre-processing techniques described in this application as being carried out by frame preprocessing modules of the inventive subject matter to enhance a key frame in some manner can be frame-based, location-based, or both. A frame-based enhancement is one that is applied to a full key frame, and a location-based enhancement is one that focuses on improving specific regions or areas of interest within a key frame or video, such as on particular objects.

Whether to apply a full-frame or location-based enhancement depends on a specific use case. Fisheye correction and low light enhancement can significantly improve an overall scene, thereby increasing the accuracy of object detection and classification models. These enhancements should thus be applied to a full key frame for optimum results.

Super resolution, although generally more resource-intensive compared to other enhancements, proves highly beneficial in specific scenarios such as license plate recognition and facial recognition. In these instances, super resolution can be applied to, e.g., object crops rather than an entire key frame.

Different enhancements are suited to different types of machine learning models. For example, consider the following pipeline: video→low light enhancement→license plate detection model→retrieve bounding boxes of license plates→apply super resolution to license plate crops→license plate number recognition. In this example, low light enhancement is used for the license plate detection model, while super resolution is applied to the output of the license plate detection model (i.e., cropped license plates). Accordingly, the input to the license plate recognition model gives rise to a need for two sequential frame-preprocessing enhancements.

Some enhancements are applicable to all key frames subject to pre-processing. Conversely, some enhancements are only required on demand-for instance, super resolution to decipher a license plate is only needed when a license plate is detected. In such cases, the enhancement can be provided as an API as opposed to integrating the enhancement into a pre-processing pipeline that all key frames are subject to.

Given each type of preprocessing has associated with it a minimum latency and a minimum resource requirement, each type of frame preprocessing described in this application can also be subject to a maximum allowable latency (e.g., per frame) and a maximum allowed resource requirement (e.g., a maximum amount of graphical processing unit (GPU) resources).

Selecting, activating, and deactivating preprocessing techniques described above can be carried out dynamically. This can involve choosing which techniques to apply and deciding whether to apply the techniques globally or locally to a key frame. Each preprocessing type's minimum latency and resource requirements can be pre-computed for global and local settings. By understanding minimum latency and resource requirements, an optimal combination of preprocessing techniques can be implemented without exceeding either latency or computational resource limits. For incoming key frames, runtime insights are collected on brightness level, histogram, blur level, and motion estimation. Using these insights, a frame preprocessing module of the inventive subject matter can determine which preprocessing technique(s) to use and whether to apply these selected methods globally or locally in a given key frame.

In any given computing environment, there can exist only finite computational resources, either GPU, CPU, some other computational resource, or any combination thereof. By developing a clear understanding of computational budgets for each preprocessing technique, a frame preprocessing unit can determine an optimal preprocessing combination based on available resources. For example, a computer or computer system's total resources for many of the operations or software functions described in this application can be described as a percent of total Floating-Point Operations Per Second (FLOPS) that the system is capable of carrying out along with a quantity of GPU memory available to the system. FLOPS (or TFLOPS) and available GPU memory can be determined according to, e.g., GPU model. For example, if a given preprocessing technique requires 1TFLOPS (at FP 16) and 1GB of GPU memory, then if we use an NVIDIA GPU with a specification of 100 TFLOPS (at FP 16) and GPU memory of 100GB, then the required usage for that technique will be 1% for each of processing power and memory usage. Embodiments of the inventive subject matter can be configured to determine GPU make and model to determine total processing capacity and available memory. Total computational output, in some embodiments, can also account for available CPU FLOPS as well as system RAM. These parameters can also be determined and considered in addition to GPU FLOP and GPU memory. In some embodiments, total computational capacity can refer to any combination of CPU, GPU, system RAM, and GPU RAM, expressed either as a percent or in FLOPS (e.g., TFLOPS, etc.) and byte (e.g., GB, TB, etc.).

In one example, a frame preprocessing module can be allocated 50% of total resources (which can include CPU, GPU, and other computing resources that may be available for frame preprocessing). Given 50% resource availability and knowing that each technique requires some amount of computational resources to apply, then an optimal combination can be determined. For example, if de-raining will require 10% of total resources, de-blurring will require 30% of total resources, and low-light enhancement will require 10% of total resources, then those three techniques can be applied while staying within a computational resource budget of 50%.

Which preprocessing techniques to apply can also depend on an analysis of a keyframe to determine the techniques that a key frame would benefit from most. Thus, the frame preprocessing module, as mentioned above, develops runtime insights that include brightness levels, histogram information, blur levels, and motion estimations. These insights can facilitate informed preprocessing technique selection.

In addition to computational resource availability, a given preprocessing technique's maximum latency can also be considered. For example, if there is a latency budget of 100 ms (e.g., 10 FPS is a minimum acceptable frame rate for selected key frames, which would leave 100 ms between frame selections), then the preprocessing techniques that are selected cannot have maximum latencies that add up to more than 100 ms. If de-raining will take 30 ms (max), de-blurring will take 40 ms (max) and low-light enhancement will take 30 ms (max), then those three could be used because their maximum possible latencies add up to 100 ms, which is within the latency budget. Preprocessing maximum latency budgets can be determined, e.g., by how much time exists between key frame selections, and thus higher key frame sampling rates lead to lower preprocessing latency budgets and vice versa.

Frame preprocessing modules of the inventive subject matter can be configured to leverage parallel processing units (e.g., CPUs, GPUs, etc.) to facilitate simultaneous application of multiple preprocessing techniques to key frames.

Thus, frame preprocessing modules of the inventive subject matter can carry out the tasks described above, which includes decoding, frame selecting, and video preprocessing before transmitting preprocessed key frames (e.g., sequentially, in real time, as a set, etc.) to a scene understanding module. In block 330, preprocessed key frames are re-streamed. Re-streaming keyframes involves re-creating a video from key frames that have been subject to pre-processing. Re-streamed key frames are then sent on to a scene understanding module.

In addition to re-streaming key frames, block 330 can carry out additional key frame selection. Key frames selected according to block 330 can be identified as being suitable for specific artificial intelligence models within a scene understanding module of the inventive subject matter. In some embodiments, block 330 sends a full re-streamed video to a scene understanding module (e.g., a re-streamed video comprising all the key frames subject to preprocessing), while in other embodiments only a subset of key frames that have been subject to preprocessing are sent to a scene understanding module. A re-streamed video can thus include all key frames, a subset of key frames, or key frames along with other frames that are introduced to fill in gaps between key frames.

In some embodiments, the frame preprocessing module can be implemented on the same hardware and can even be part of the same software implementation as the scene understanding module. Thus, although the term “transmit” may be used to describe sending key frames from a frame preprocessing module to a scene understanding module, because modules exist as software implementations, the term can be considered as describing the ability of software of the inventive subject matter to use key frames once those key frames have been identified by the frame preprocessing module of the same software (or different software in instances where, e.g., different software tasks are distributed across different computing devices).

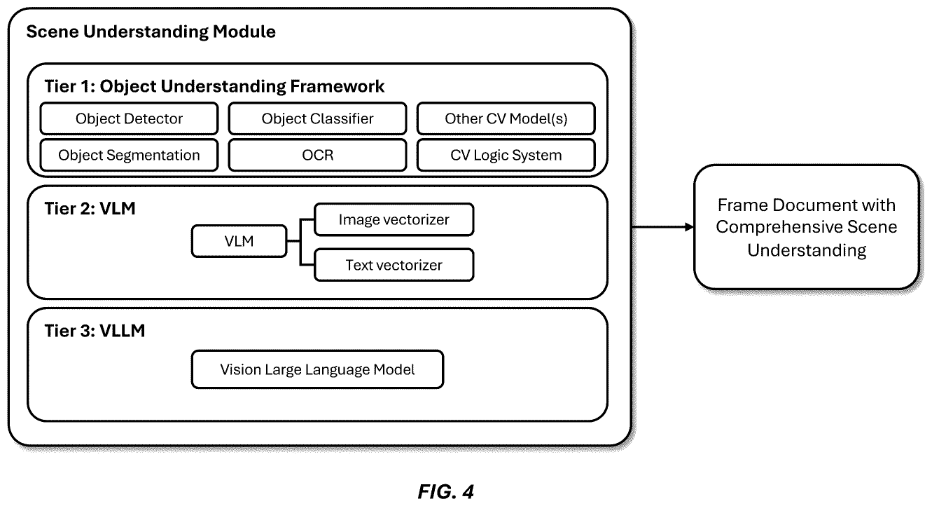

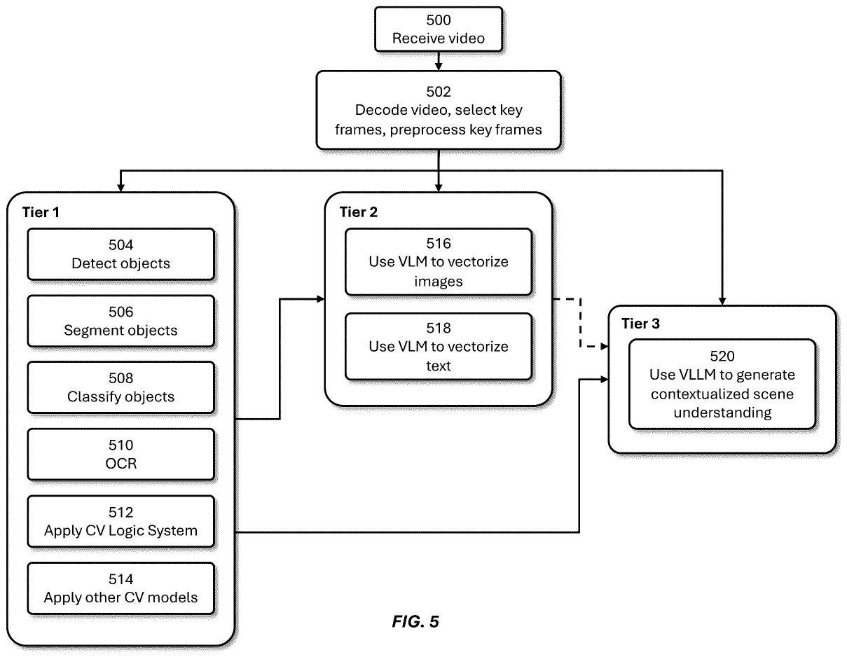

Scene understanding modules of the inventive subject matter, as shown in FIG. 4, feature a multi-tiered approach to scene understanding, which includes tools that help to obtain deep insights of scenes that are passed to the scene understanding module from the frame preprocessing module. Tier 1 implements an object understanding framework, Tier 2 implements a VLM (e.g., OpenCLIP, CLIP, ALIGN, ViLT, or the like), and Tier 3 implements a VLLM (Vision Large Language Model). A scene understanding module of the inventive subject matter thus receives key frames that has been preprocessed by the frame preprocessing module so that each tier within the scene understanding module is able to process those key frames more efficiently.

Key frames are processed by each of the tiers, starting with Tier 1. Tier 1 receives preprocessed key frames from the frame preprocessing module and creates an object level understanding of what is shown in the key frames (and by extension in a scene that the key frames represent). Tier 1 can thus facilitate detection and generation of alerts according to predefined rules and settings. For example, an alert can be set to trigger when a car is detected in one or more of the key frames of a scene, and a car can be detected according to an object understanding framework implemented in Tier 1.

The object understanding framework in Tier 1 is configured for high key frame throughput capacity with support for multiple, simultaneous real-time streams. It can process key frames to carry out tasks including object detection, object classification, and OCR. Because it is a highly optimized pipeline, an object understanding framework implemented by Tier 1 can be capable of processing multiple key frames per second without any drop in performance. Thus, Tier 1 carries out basic object identification tasks.

Tier 1 (i.e., the object understanding framework) features a number of sub-modules, including one or more object detectors, one or more object classifiers, an object segmentation module, an OCR module, a computer vision logic system, and other computer vision models. Each of these modules can work together or separately as needed to create an output that can facilitate deep understanding of a scene.

Although in some embodiments, certain sub-modules act before or after other modules, it should be understood that no specific order of operations for sub-modules can be elucidated because how an object understanding framework prioritizes use of its sub-modules is embodiment and circumstance dependent. Though while sub-module order depends on a domain or a use case, in most instances object detection comes first, followed by object segmentation to get more accurate boundaries of a detected object. In some embodiments, though, a Segment Anything Model (SAM) can be implemented. SAM models can segment out all important objects in a set of key frames without using a separate object detector.

Object detector modules are responsible for detecting objects that exist in key frames. Object detection is a technique that uses neural networks to localize and classify objects in images. It involves training computers to see as humans do, specifically by recognizing and classifying objects according to semantic categories. Object detection combines subtasks of object localization and classification to simultaneously estimate the location and type of object instances in one or more key frames.

Object segmentation, also known as image segmentation, is the process of partitioning a digital image into multiple image segments, also known as image regions or image objects. The goal of segmentation is to simplify and/or change the representation of an image into something that is more meaningful and easier to analyze by, e.g., isolating an object in a key frame. This technique is typically used to locate objects and boundaries (lines, curves, etc.) in images. Each of the pixels in a region are similar with respect to some characteristic such as color, intensity, or texture. Thus, an object segmentation module is responsible for carrying out object segmentation for objects that appear in key frames.

In some embodiments, an OCR module is also included. An OCR module can be responsible for recognizing and extracting text from key frames. OCR modules of the inventive subject matter can be implemented to enable text searching within key frames of a scene that is subject to processing by a scene understanding module (and specifically Tier 1 of the inventive subject matter).

Object understanding frameworks can also include computer vision (CV) logic systems. Computer vision logic systems are designed to enable computers to interpret and understand visual information. These systems can use a combination of image processing, machine learning, and deep learning techniques to analyze images and videos. They can perform tasks such as object detection, image classification, and scene understanding. Embodiments thus implement computer vision logic systems to facilitate scene understanding. For example, once object detection and segmentation have taken place for a key frame, a computer vision logic system can make sense of objects present in the key frame and, as more key frames are analyzed, a computer vision logic system can also discern information relating to how multiple objects interact in a scene.

Computer vision logic systems receive an input and produce and output. Inputs can include outputs from computer vision models (e.g., computer vision models that act as detectors, at as classifiers, create segmentations, and so on) and regions of interest (ROI) that are either pre-defined or given by a user. A computer vision logic system is thus responsible for gathering rule-based information (e.g., about one or more objects) from key frames, including: a tracking ID, a location of an object, a duration that an object appears in a scene as represented by key frames, an indicator as to whether an object is moving or stationary, a direction of movement, and whether an object is in a region of interest. Outputs from a computer vision logic system can be used for, e.g., alert generation.

A region of interest (ROI) refers to a specific area within a key frame or image that is of particular importance for analysis or processing. This region is predefined or user-selected based on its relevance to the task or application at hand. Within the context of scene understanding modules, ROIs are used to focus computational efforts and rules on objects or activities occurring within those specified areas.

For example, an ROI might be defined around a pedestrian crossing in surveillance footage to monitor for vehicles or pedestrians. The computer vision logic system can track objects within the ROI, analyzing their presence, movement, and interactions. By isolating and prioritizing ROIs, systems can optimize their resource usage and provide targeted outputs, such as generating alerts when specific rules are met.

Object understanding frameworks of the inventive subject matter implement a number of features that improve efficiency. For example, in some embodiments, smaller computer vision models can be used. Ordinarily, computer vision models are trained using a machine learning library. For example, PyTorch can be used to enable quick and easy model training. PyTorch is an open-source machine learning library for Python developed by Facebook's AI Research Lab (FAIR). It is one of the most popular deep learning frameworks, alongside others such as TensorFlow and PaddlePaddle. PyTorch offers a rich ecosystem of tools and libraries that support development in computer vision, natural language processing (NLP), and more.

Trained computer vision models can have assigned weights in, e.g., FP32 format. FP32, also known as single-precision floating-point format, is a computer number format that occupies 32 bits in memory. It represents a wide dynamic range of numeric values by using a floating radix point. This format is commonly used in scientific calculations and AI/deep learning applications. FP32 consists of 1 bit for the sign, 8 bits for the exponent, and 23 bits for the mantissa, allowing it to represent numbers with approximately 7-9 significant decimal digits. Quantization can then be used to convert computer vision models to use either FP16 or INT8 weights. This reduces model size and increases inference speed without giving rise to meaningful impacts to accuracy. Another way of reducing model size and increasing inference speed is through distillation. Trained computer vision models (i.e., teacher models) can be used further to train smaller computer vision models (i.e., student models).

In some embodiments, computer vision models can be designed to efficiently use available resources. Because multiple computer vision models can be used in a scene understanding module, object understanding frameworks of the inventive subject matter can be optimized to minimize data transfer from host (e.g., CPU) to device (e.g., GPU) and vice versa. Parallel processing can also be implemented so that independent computer vision models can run simultaneously. Preprocessing modules of the inventive subject matter can thus perform real-time monitoring of computational resource utilization and dynamically reconfigure the set of preprocessing techniques implemented for each given key frame to prevent resource exhaustion.

An object understanding framework of Tier 1 thus uses all or a subset of the identified sub-modules to discern information about objects that appear in key frames that correspond to a scene. Object metadata that can be generated can include rule-based enrichments such as a tracking ID, a size/aspect ratio, a location (e.g., bbox, center), whether the object is stationary or moving, a movement direction (if applicable), an indicator as to whether an object exists within an ROI, and a duration that an object is present within a scene as represented by a set of key frames. Model based enrichments can also be generated, including an object crop embedding vector, object specific attributes, object segmentations, and so on.

Outputs from Tier 1 are structured and stored in either a relational or a non-relational database. A relational database organizes data into structured tables consisting of rows and columns, where relationships between tables are maintained through primary and foreign keys. Relational databases generally use SQL to manage and manipulate data efficiently, ensuring data integrity and enabling advanced operations like joining tables and filtering information. A non-relational database (e.g., a NoSQL database) is a type of database that stores and retrieves data without requiring a fixed schema or relationships between tables, unlike traditional relational databases. It is designed for scalability and flexibility, often used in applications involving large volumes of unstructured or semi-structured data, such as documents, key-value pairs, graphs, or wide-column stores.

Once key frames have been processed according to Tier 1, objects in the key frames will have been identified and segmented (e.g., into a segmented object image), any text will have been recognized via optical character recognition (OCR), and interactions between objects in the key frames will be discerned and understood. In the broader context of computer vision, understanding object interactions means recognizing how objects within key frames interact with each other over time. This involves tracking objects, analyzing their movements, and understanding their behaviors and relationships. For instance, in surveillance video content, understanding object-object and human-object interactions is fundamental. Visual tracking algorithms follow objects manipulated by humans as well as objects that are impacted or affected by other objects, providing useful information to model such interactions. This capability is essential for applications like surveillance, where recognizing and understanding interactions between humans and/or objects in a scene or video can enhance interaction realism. Thus, Tier 1 generates object information, where object information can include any of the parameters, metadata, or information about an object discussed regarding Tier 1.

Tier 2 implements a Vision and Language Model, or VLM (e.g., OpenCLIP, CLIP, ALIGN, ViLT, or the like) that can use the object level understanding developed in Tier 1 to vectorize objects (e.g., images cropped to show only or predominantly the object) and images (e.g., images containing visual information that a user may want to search for) within the key frames, and in some cases to vectorize entire key frames. Thus, outputs from Tier 1 can be used in Tier 2 in several ways. For example, Tier 1 outputs can facilitate vectorizing cropped images that contain objects (e.g., for use with text-based image searching or with VLLM processing in Tier 3). One or more of the sub-modules in Tier 1 can detect objects (e.g., vehicles, people, traffic lights, posters, road signs, etc.) and then create bounding boxes around those objects. The bounding boxes can then be cropped and resized (e.g., to a VLM's required image input size) before being vectorized using a VLM's image encoder.

Objects are detected and preprocessed (e.g., cropped, resized, etc.) before being vectorized because many VLMs need images to have specific dimensions (e.g., 224×224 pixels) before they can be processed. Thus, in embodiments of the inventive subject matter, objects in a key frame are each cropped and vectorized separately so that information is not lost in resizing. In some instances, a full key frame without any resizing or cropping can be vectorized, which can facilitate searching or VLLM processing that captures more information about a scene (e.g., “find a scene showing a road crossing on a rainy day”).

By carrying out the vectorizing tasks described above, a VLM (e.g., OpenCLIP, CLIP, ALIGN, ViLT, or the like) can be used to relate natural language (e.g., user queries or VLLM queries) with key frames and objects in those key frames making it possible to conduct text searches for those objects. A VLM of the inventive subject matter can be configured to accommodate multiple real-time streams of key frames—where rate that key frames can be processed depends on, e.g., frame selection that occurs in the frame preprocessing module—simultaneously without sacrificing video processing capabilities. When Tier 2 is described in this application as handling or processing key frames (or similar language), it should be understood that Tier 2 is vectorizing objects, images, and, in some cases, entire key frames.

Tier 2's high throughput capabilities can be useful in, e.g., embodiments where multiple security cameras are fed into one or more frame preprocessing modules and resulting key frames are passed to a single scene understanding module (e.g., a scene understanding module running on restricted hardware environment like a personal computer). A VLM implemented in Tier 2 can be tuned using application and domain specific datasets (e.g., datasets that relate objects that appear in images to text that are sourced from, for example, surveillance footage). And VLMs of the inventive subject matter can feature at least two modules: an image encoder and a text encoder. VLMs can use those encoders to vectorize images and text to facilitate vectorized searching and VLLM processing.

A practical example of a VLM model is one developed by OpenAI, CLIP, which is trained on a variety of (image, text) pairs. OpenAI's model can predict the most relevant text snippet given an image, without directly optimizing for the task, similar to the zero-shot capabilities of GPT-2 and GPT-3. The VLM can be fine-tuned to custom datasets and is capable of performing tasks such as image classification and finding the similarity between an image and a set of text descriptions. Tier 2 thus uses output from Tier 1. Where Tier 1 detects objects, Tier 2 vectorizes those objects to facilitate text-based object searching. For example, a searchable interface could be provided that is overlaid over video content as it plays.

By vectorizing images containing objects that are present in key frames, Tier 2 makes it possible to use language to associate objects with other objects (e.g., objects or people). By linguistically associating objects with other objects that appear in a set of key frames, events that occur in the corresponding scene can be better described.

Because key frames (e.g., segmented objects within key frames, entire key frames, etc.) have been processed according to Tier 1 and then vectorized according to Tier 2, efficient text-based searches or text-based VLLM processing of scene content is made possible. Vectorized searching, also known as vector search, is a method in artificial intelligence and data retrieval that uses mathematical vectors to represent and efficiently search through complex, unstructured data. Unlike traditional keyword-based search methods, vector search represents data points as vectors in a highly-dimensional space, allowing for more sophisticated and accurate searches. This method is particularly useful for finding related data by comparing the similarity of query vectors to data vectors, often using algorithms like cosine similarity or Euclidean distance.

Thus, when objects are identified in key frames and then vectorized, natural language queries can be received, vectorized, and used to search through key frames to find images or objects in a scene. For example, users can conduct vector searches that can match queries to the most relevant vectorized object(s) in a scene. Vectorized searching can also be used to generate contextualized descriptions of how multiple objects in a scene interact with one another (e.g., “show a red car colliding with a blue car”).

As mentioned above, Tier 2 can vectorize object image crops and/or full key frames to facilitate text-image and image-image search. A text-image search is one where a text query is input and an image result is returned, and an image-image search is one in which a user uploads an image of an object and an image result is returned.

Outputs from Tier 2 are vectors and are stored in a database that supports vectors, preferably the same database used to store outputs from Tier 1.

In addition to vectorized searching, Tier 2 facilitates processing by a VLLM in Tier 3. Tier 3 implements one or more VLLMs (Vision Large Language Models) to carry out additional scene processing to attain a contextualized understanding of a scene. A VLLM is a type of multimodal model that is capable of interpreting both visual and textual information. VLLMs can be commercially distributed (e.g., GPT) or open source (e.g., InternVL2, Qwen2-VL, etc.). Open source VLLMs can be useful for customization and fine-tuning purposes. Other suitable multimodal models capable of interpreting at least both visual and textual information can be used in some embodiments, and multimodal models capable of interpreting other information types in addition to visual and textual, including audio, can be implemented in some embodiments.

In general, the VLLM implemented in Tier 3 will be slower and less accurate for tasks that are undertaken by, e.g., Tier 1, which is why those tasks are taken out of the purview of Tier 3 in the first place. For example, object or text detection and segmentation can be handled by a VLLM, but because VLLMs require far more computing resources than the dedicated sub-modules that can exist in Tier 1, Tier 1 is responsible for those tasks. Moreover, outputs from Tier 1 can strengthen reasoning capabilities of VLLM models in Tier 3. For instance, a VLLM could miss a smaller object that appears in a video, but the specialized sub-modules in Tier 1 may not have issues detecting that same object, and when a small, miss-able object is detected in Tier 1, it ensures that object can be interpreted by a VLLM in Tier 3.

Tier 1 outputs (e.g., bounding box locations of an object, an augmented form with an object segmented out to have a specific highlight color, or each object annotated with a tracking ID, or the like) can thus provide extra information that helps a VLLM in Tier 3 to better understand a scene. For example, say there are five cars in a four-lane road. Tier 1 could detect all the cars, draw bounding boxes around them, and associate tracking IDs with each of the cars. This task ensures that the VLLM in Tier 3 considers all five of the cars when the VLLM on its own might not have detected all five.

In some situations, VLLMs are not good at detecting domain specific objects (i.e., objects that exist within a pre-defined set of objects such as medical images, vehicles, and so on). But Tier 1 can find domain specific objects more easily because Tier 1 is configured specifically for object detection, regardless of object domain.

VLLMs of the inventive subject matter can be configured to carry out open vocabulary object detection. Thus, in general, VLLMs can receive different types of input, including a query in the form of one or more of any of an image (or a set of images), and/or text, where the text could be a simple question or a complex instruction. For example, a VLLM can receive an object description as text and use that object description to output bounding boxes containing the described object. In this way, a VLLM can make user-specified object detection unnecessary. For example, a user might not know all objects that should be detected in a set of key frames. A VLLM, on the other hand, does not need a list of objects to detect and can instead detect objects in key frames as needed. VLLMs are comparatively slower than traditional detectors and classifiers, which is why Tiers 1 and 2 carry out tasks to minimize how much processing power will be required by a VLLM to carry out the tasks of Tier 3. VLLMs of the inventive subject matter are thus configured to receive an image or video along with text (or just text) as a query and to generate a text answer as an output. The output can be formatted as, e.g., JSON, plain text, and so on, and it can be included in a detailed frame document that scene understanding modules of the inventive subject matter are configured to generate.

Because VLLMs can simultaneously process both text and images to provide a textual output, scene understanding modules of the inventive subject matter are capable of using key frames to generate in-depth textual descriptions of a scene that are further enriched using information available via Tier 1 and Tier 2 processing. Tier 2 output can optionally be used in Tier 3, depending on Tier 3 model architecture as discussed below regarding image encoding. Although VLLMs can provide information regarding objects and their interactions, VLLMs are not deterministic, which can make them unreliable. To keep VLLMs grounded, so to speak, information from Tier 1 can be used to minimize instances of a VLLM deviating from reality by focusing it on objects that Tier 1 has identified.

A distinguishing feature of VLLMs is their ability to perform tasks requiring high-level reasoning across both text and visual modalities. For instance, they can generate detailed captions for images, provide in-depth explanations for visual content, or engage in multi-turn dialogues that incorporate visual context. The incorporation of LLMs like GPT within VLLMs allows for rich contextual interpretation, enabling tasks such as storytelling from images, answering detailed questions about visual scenes, and providing multimodal reasoning in fields like education, healthcare, and creative content generation. This synthesis of vision and language capabilities positions VLLMs as transformative tools for a wide range of applications.

Modern VLLMs tend to be slow, owing to trade-offs between size and performance. VLLMs are also generally capable of processing only a single real-time stream at a much lower frame rate. Because of these limitations, scene understanding modules of the inventive subject matter take the three-tiered approach described in this application. By running video content or scenes through Tiers 1 and 2 before applying a VLLM in Tier 3, the Tier 3 VLLM can run more efficiently because, in some embodiments, it would not need to carry out any of the tasks already performed by Tiers 1 and 2.

VLLMs use an image encoder to understand images. In some cases, a VLLM can use a VLM (e.g., OpenCLIP, CLIP, ALIGN, ViLT, or the like) as an image encoder. Because VLMs are bimodal and can handle both images and text, embodiments that use a VLM for image encoding give rise to two types of VLLM architectures: VLLMs that keep the image encoder frozen and only fine-tune the language model part, and VLLMs that fine-tune both the image encoder and the language model.

In embodiments where Tier 3 requires a VLM image encoder that has been frozen and not fine-tuned, then the VLM from Tier 2 can be used for image encoder (e.g., OpenCLIP, CLIP, ALIGN, ViLT, or the like). In other words, in some situations, the image encoder used in Tier 3 can be taken from Tier 2 in situations where the image encoder from the VLM in Tier 2 is also adequate for Tier 3.

Reusing the VLM from Tier 2 can reduce hardware resource consumption and improve efficiency. But where Tier 3 requires a VLM image encoder that is different from the VLM image encoder in Tier 2, then the VLM image encoder in Tier 2 is no longer considered to exist in the same space as the VLM text encoder and it instead enters the space of the VLLM. In such situations, the VLM encoder cannot be reused from Tier 2. In other words, if Tier 3 has image encoding requirements that cannot be satisfied by the VLM image encoder from Tier 2, then the Tier 2 VLM image encoder cannot be reused in Tier 3. A VLLM in Tier 3 can thus be configured to associate text queries with contextual information from key frames that are processed by Tier 1 to gather information about, e.g., weather, lighting, background, foreground, or other user defined parameters. Tier 3 text queries are set (e.g., pre-defined) before processing begins, and they can be applied to all key frames. Outputs from these queries can then be used in creating a frame document that the scene understanding module is configured to output.

An example query that can be applied in Tier 3 is: “describe the weather, lighting, background objects, foreground objects.” A scene understanding module of the inventive subject matter could incorporate a response to this query in a frame document. For example, when applying this query to key frame, the response to the query could be: “The weather is sunny, and the lighting is good. There is a billboard in the background. In the foreground are two persons.”

Thus, Tier 3 can use one or more VLLMs to generate general scene context and domain specific scene context. General scene context includes contextualized text descriptions of a scene (e.g., based on processing undertaken using key frames corresponding to the scene), foreground objects, background objects, weather, lighting, signs and posters, and so on. Domain specific scene context can include general scene descriptions. Outputs from Tier 3 can include text and can be structured (in case VLLM generates a JSON), or unstructured (in case VLLM generated a paragraph). VLLM outputs can be stored in at least three different ways: raw text output, vectorized text output (e.g., for fast retrieval) and knowledge graphs. Raw text output is stored by default, and further processing can be performed on the raw text output to make retrieval easier. As vectorized text, the raw text is divided into chunks and each chunk is vectorized and stored in a vector database. With knowledge graphs, entities and relationships are extracted from the raw text. Tier 3 outputs can be incorporated into a detailed frame document, as described below.

Once all Tiers 1, 2, and 3 have been applied via the scene understanding module, the scene understanding module outputs a detailed frame document that features comprehensive scene understanding. Frame documents of the inventive subject matter can be formatted as, e.g., JSON, text, or the like. Frame documents can be formatted for human user consumption (e.g., arranged and formatted in a way that is easy for a user to interpret and understand), they can be formatted to contain information in one or more data structures that are conducive to information storage and later retrievable by a computer, or, in some embodiments, both. Outputs from scene understanding modules of the inventive subject matter can, for example, be used to create a user interface having a search feature that allows users to use plain language text searching to search through video content.

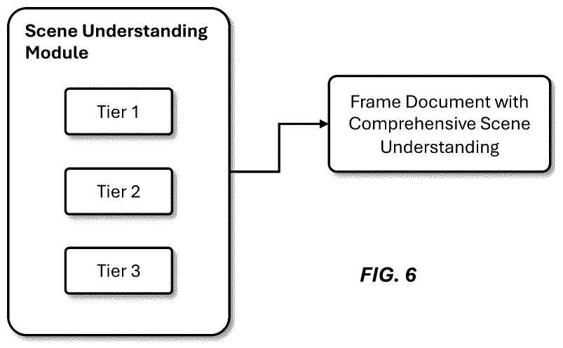

FIG. 5 is a flowchart demonstrating how a method based on the inventive subject matter described in this application can be organized. It should be understood that embodiments described in relation to FIGS. 5 and 6 can incorporate all subject matter described in this application as it relates to different method steps, whether explicitly restated in describing these method steps or disclosed above in the context of FIGS. 1-4.

In step 500, video is received by a frame preprocessing module from a video source. Possible video sources are described above in FIG. 1. The frame preprocessing module exists on, e.g., a computing device or set of computing devices, whether local, remote, cloud, etc. In step 502, the frame preprocessing module decodes the video and selects key frames from the decoded video. In some embodiments, the frame preprocessing module can perform further preprocessing by, e.g., resizing key frames, cropping key frames, and so on, as described above.

Once the frame preprocessing module has completed its tasks, key frames are ready for additional processing by Tiers 1, 2, and 3. Each key frame is thus subject to the object understanding framework of Tier 1, which includes several steps. Step 504 describes object detection, step 506 describes object segmentation, step 508 describes object classification, step 510 describes applying optical character recognition (OCR), step 512 describes applying a computer vision logic system, and step 514 describes applying other computer vision models (which can be done on an as-needed basis). Each of steps 504-514 are described in detail above and in relation to Tier 1's object understanding framework. In some embodiments, not every one of steps 504-514 must be carried out for Tier 1 to be considered complete.

Once Tier 1 processing is complete, and an object level understanding of each key frame has been developed. Tiers 2 and 3 can then use information from Tier 1 to conduct further processing. Although Tiers 1, 2, and 3 are not shown as operating in sequence (e.g., arrows from step 502 go to each of the Tiers individually), it should be understood from discussion of the Tiers presented in this application that, in some embodiments, processing that takes place within individual Tiers can be used in other Tiers in sequence.

Tier 2 uses a VLM to carry out its steps. In step 516, the VLM vectorizes (sometimes describes as “encoding”) images, and in step 518, the VLM vectorizes text. The images vectorized in step 516 can include key frames or portions of key frames. For example, if an object is segmented out in Tier 1, then the segmented image may be vectorized, while in other circumstances entire key frames are vectorized. Text that can be vectorized includes text content that appears in a key frame or segmented key frame. For example, if in step 510, text on a sign that appears in a key frame is subject to OCR, then that text can be vectorized in step 518.

Metadata text generated in Tier 1 can also be vectorized. For example, object classification carried out in step 508 can generate object classification metadata (e.g., a text-based object description), and that object classification metadata can then be vectorized in step 518. Text and image content that is vectorized in steps 516 and 518 can be used in Tier 3 as well as in a frame document that the scene understanding module generates, as described in FIG. 6.

Tier 3 features step 520, which involves using a VLLM to generate a contextualized scene understanding. As discussed above, the VLLM in Tier 3 runs pre-defined queries that generate contextual information about content in key frames (e.g., weather, lighting, and so on as described above). Carrying out Tiers 1 and 2 before moving to Tier 3 can improve the performance of step 520 in Tier 3 for the reasons discussed above in more detail.

Once Tiers 1-3 (and steps 504-520) have been applied to key frames, the scene understanding module (which comprises Tiers 1-3) can generate a frame document having comprehensive scene understanding. Thus, for example, the frame document can include object understandings and metadata generated in Tier 1, it can include vectorized images and text generated in Tier 2, and it can include contextualized scene information generated in Tier 3. In some embodiments, the contextualized scene information can incorporate information form Tiers 1 and 2.

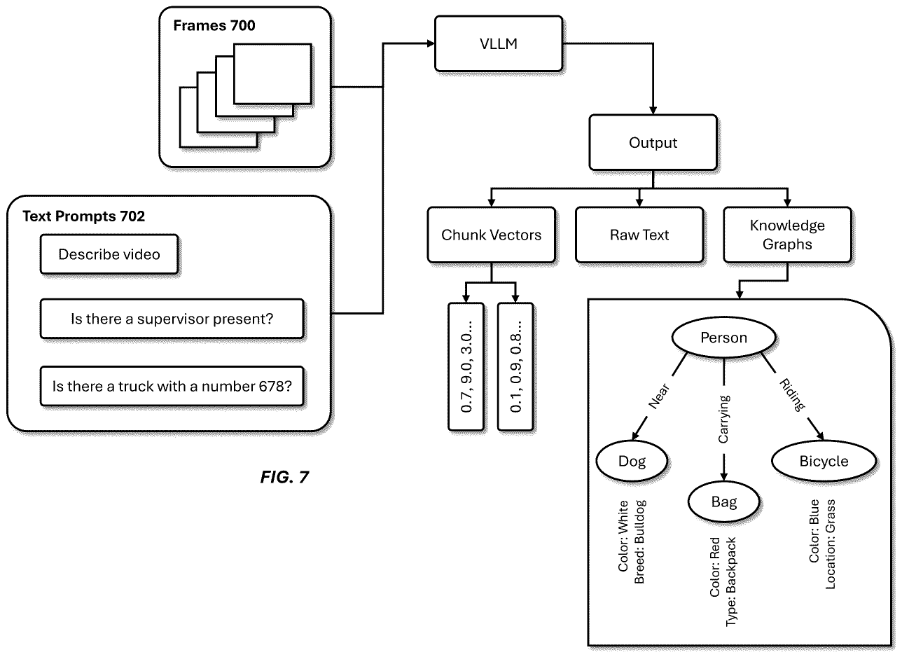

FIG. 7 shows a schematic of how a domain-specific implementation of an embodiment of the inventive subject matter can be configured. Domain-specific Video Large Language Models (VLLMs) bring advantages when applied within multi-tiered video content understanding frameworks as described in the inventive subject matter. These models optimize the extraction, contextualization, and utilization of video content, offering significant improvements over generic AI systems when used to process video content having a known or knowable domain.

One advantage of domain-specific VLLMs is their ability to generate highly contextualized scene understandings. By leveraging queries tailored to specific video domains, domain-specific VLLMs enable systems to interpret nuanced aspects of a scene such as weather conditions, lighting variations, and object interactions. This targeted contextualization ensures that each scene is analyzed with precision and relevance, addressing unique requirements of particular applications, such as surveillance or cinematic analysis.

Generic VLLM models often lack the ability to refine their output for specific domains. Domain-specific VLLMs overcome this limitation by leveraging queries designed to align with the nature of the video content. For instance, in a retail domain, queries could focus on customer behavior patterns, while in a traffic monitoring domain, they may prioritize vehicle classifications and flow dynamics. This type of specialization reduces errors and enhances the reliability of the generated insights.

In embodiments of the inventive subject matter, domain-specific VLLMs operate effectively within Tier 3 of the scene understanding module. Their role in synthesizing data from Tier 1 (object understanding) and Tier 2 (vectorization) ensures that the contextualized outputs are enriched by prior processing steps. This integration allows VLLMs to utilize metadata, vectorized images, and text efficiently, resulting in comprehensive scene descriptions that are both detailed and actionable.

Video content often requires real-time analysis, such as in security or live broadcasting scenarios, and real-time analysis capabilities are paramount for embodiments described in this application. Domain-specific VLLMs are designed to handle high-speed computations without compromising accuracy, and this capability used in association with frame selection and frame preprocessing technique described above enable real-time video analysis and VLLM contextualization. Tailored algorithms and focused scope also reduce computational overhead, making them ideal for applications demanding rapid and precise scene interpretation.

Although specialized to particular fields, domain-specific VLLMs retain the flexibility to adapt to various domains through fine-tuning queries and algorithms. This adaptability ensures that the models can be employed across multiple industries, from healthcare to entertainment, further enhancing their utility and return on investment.

Domain-specific VLLMs of the inventive subject matter can also generate outputs that can be formatted into user-friendly frame documents. These documents facilitate the creation of queryable interfaces, allowing users to search through video content using plain language. The intuitive access to insights fosters better decision-making and improves user experience.

The integration of domain-specific VLLMs within the multi-tiered video content understanding framework elevates the performance, accuracy, and adaptability of AI systems. Their ability to provide contextualized insights, optimize real-time processing, and enhance user interfaces underscores their indispensability in modern video analysis applications. Whether applied to surveillance, media, or industrial domains, domain-specific VLLMs represent a leap forward in harnessing the potential of artificial intelligence for video content interpretation.

Advancements in VLLMs also allow embodiments of the inventive subject matter to perform temporal localization in video content. VILA (Video-Language Alignment) and NVILA (both types of Visual Language Models) both use discrete time tokens to identify when specific activities start and stop, where the specific activity can be mentioned in a prompt. Activities that VLLMs can identify depend on the dataset they have been trained on. Carrying out this same task using a more traditional approach would require fine-tuning of action recognition models and rule logic—both of which a VLLM can do without, making VLLMs far more robust than traditional methods.

Open-source VLLMs are generally inadequate in domain-specific scenarios (e.g., in surveillance where a specific domain or domains will always be monitored). VLLMs are trained with large amounts of “general” data, but they can lack domain-specific data. Thus a general VLLM may be capable of understanding general information about a scene, but when tasked with prompts relating to specific domains such as seaports, prisons, parking lots, and so forth, a general VLLM would fail to generate meaningful, domain-specific insights and context.

Each possible domain can have different terminologies for objects and activities. For example, a general (e.g., open source) VLLM might understand a “spreader” in a seaport to be a “crane.” While these two things are similar, they are not the same, and a VLLM unable to interpret a prompt relating to a “spreader” can lead to issues if the VLLM only recognizes a “crane.” Domains can also have specific activities that may not be found in a general training set and thus may not be found in a general VLLM. For example a VLLM trained on a generalized training dataset may not understand that more than four people working on a spreader is a safety violation, whereas a domain-specific training dataset used for to train a domain-specific VLLM would have this understanding. Additionally, general training datasets do not include proprietary data from certain domains, such as prison cells. General VLLMs would thus fail to recognize many domain specific objects and activities, and using a general, open source VLLM in a domain specific application can yield subpar or even unusable results.

Some limitations of a general VLLM can be alleviated by fine tuning the prompts that are fed to them. For example, a prompt can feature an instruction that the word “spreader” should be used instead of the word “crane.” But even with a fine-tuned prompt, a general VLLM might fail to distinguish between an actual crane and a spreader, because it does not actually know what a spreader is, it just knows to call what it identifies as a crane a “spreader.” Moreover, the more domain-specific training dataset distribution deviates from publicly available datasets, the more challenging it becomes to perform prompt fine-tuning. Thus, supervised model fine-tuning, where domain-specific datasets are prepared to fine-tune, e.g., part of a VLLM or a full VLLM.

VLLMs require more GPU VRAM to run compared to traditional computer vision models. For example, a four Activation-aware Weight Quantization (AWQ) quantized VLLM may take ˜6GB GPU VRAM for 8-frame inference, while a YOLO detector model with TensorRT inference might take only 500MB for 8-frame inference. The YOLO model's latency would remain about the same as the VLLM as it only outputs bounding boxes and probabilities, while the latency of the VLLM can change depending on how much text it generates. The more detailed the text, the higher the latency. Because of their higher resource requirements and higher latency, VLLMs cannot presently be used to solve all problems, and judicial use of traditional models and VLLMs is necessary. It may be the case that in future, with more capable computer systems, VLLMs and traditional models can be used without concern for computer resources.

Several data preparation and fine-tuning strategies can be implemented to improve domain-specific VLLMs. Several trainable/fine-tunable VLLM modules can be fine-tuned including vision encoders, multimodal projectors, and LLMs. Vision encoders are responsible for extracting information from images, multimodal projectors are responsible for aligning information extracted from images with an LLM, and LLMs are responsible for taking visual information into account to generate a response. Determining which modules to fine-tune depends on capabilities expected of a VLLM after fine-tuning. For example, if a VLLM will be deployed in a general domain, but it is expected to follow instructions, then the LLM module (e.g., the text decoder) and the multimodal projector module can be fine-tuned. In this example, the vision encoder module is already trained on anticipated objects and activities for the contemplated domain.

In another example, if a VLLM is to be deployed in a novel domain that has new objects and activities, then the LLM, the projector, and the vision encoder can all be fine-tuned. All three need to be fine-tuned because in this scenario, the image encoder needs to be trained for the new objects and activities that it will encounter in the novel domain.

Thus, general VLLMs have shortcomings when implemented into specific domains. These shortcomings include a lack of information alignment between VLLM knowledge and actual knowledge, that a VLLM is not trained for certain objects and activities associated with a specific domain, and that the VLLM is not trained on scenes related to a specific domain. For example, for the query, “Is there a security lapse in the video?”, a general VLLM has no context for what a security lapse is. Whether a video shows a safety lapse is domain specific. For an industrial domain, a safety lapse could occur when workers are not wearing safety vests, or an inspector is not present at a job site. For road safety, it might mean a car running a red light.

Data preparation and labelling to carry out model fine tuning can help to address the issues identified above. Fine-tuning a dataset can involve fine-tuning both image(s) and text instructions. A data preparation pipeline for VLLM fine-tuning can follow several steps, including collecting domain image and video data, preparing a chat format dataset, and then fine-tuning the VLLM.

Domain image and video data can include domain specific objects and activities. For example, if the domain is a seaport, then objects can include spreaders, cargo containers, forklifts, and so forth, while activities can include loading/unloading cargo, operating the spreader, operating the forklift, and so on. A chat dataset for VLLM fine-tuning typically comprises conversational data that includes both text and visual elements. This dataset is used to train models to understand and generate responses that are contextually relevant and coherent in a conversational setting. The data can include various types of interactions, such as question-answer pairs, dialogues, and multi-turn conversations, often accompanied by images or videos to provide visual context. Question-answer pairs can feature questions in the grammatical sense (e.g., ending with a question mark), but questions can also be stated as directives (e.g., “tell me how many trucks are present). For purposes of the inventive subject matter, the term “question” refers to all possible prompts or queries that can be paired with an answer.

A question-answer pair, for example, could ask, “Are there any heavy goods vehicles present?” and be answered with “No, there are only motorcycles present.” Some question-answer pairs can relate to spatio-temporal object interactions. For example, “When was the truck with number 8909 seen?” could be paired with “From 00:10 to 00:43.” And the question, “Is there any person standing on the right side of the truck?” can be paired with the answer, “Yes, there are four people standing on the right side of the truck. One of them is female and other three are male.” Some question-answer pairs can relate to OCR. For example a question could ask, “What numbers are associated with the visible trucks?” and be paired with the answer, “Trucks with number 6787, 9898, 2758 and 0989 are parked on the right side of the frame.” And some question-answer pairs can be useful for generating detailed descriptions of information that could be required for a domain. For example, the directive, “Describe the video in detail” can be paired with an answer that begins with “the video shows . . . ” and would go on to describe all details from the video that are relevant to the domain of the video.

VLLM fine-tuning is then performed using, e.g., PEFT (Parameter-Efficient Fine-Tuning) such as Low-Rank Adaptation (LoRA) or Quantized Low-Rank Adaptation (QLoRA). LoRA is a parameter-efficient fine-tuning approach designed to adapt large pretrained models to specific tasks without the need to modify or retrain the entire model. The core idea of LoRA is to introduce low-rank matrices into the existing weights of a model, allowing task-specific parameters to be added while keeping the pretrained weights frozen. By doing so, LoRA drastically reduces the number of trainable parameters, making the fine-tuning process computationally efficient and less memory-intensive. The low-rank matrices act as a lightweight overlay that captures the adjustments required for the new task, enabling the model to specialize in a domain or task without forgetting its generalizable knowledge.

LoRA is particularly advantageous for resource-constrained environments or for tasks requiring frequent adaptation to new domains, as it avoids the prohibitive cost of full model retraining. LoRA's modularity ensures that the base model remains intact, allowing for multiple fine-tunings to be performed across varying tasks or domains using separate low-rank matrices. This adaptability makes LoRA a practical solution for real-world applications like domain-specific video-language learning models, where new objects, activities, or textual interpretations must be incorporated dynamically. Its efficiency, combined with its flexibility, has positioned LoRA as a transformative method in the fine-tuning of large-scale machine learning models.

QLoRA, on the other hand, is an advanced parameter-efficient fine-tuning method designed to optimize large-scale machine learning models for specific tasks while significantly reducing computational and memory requirements. QLoRA builds on the foundations of Low-Rank Adaptation (LoRA), which introduces low-rank matrices into a model's weight structure to adapt its general-purpose knowledge to specialized domains without modifying its core parameters. The quantization aspect further enhances this process by compressing the model's data representation into lower-bit formats, such as 4-bit or 8-bit integers, reducing the memory footprint while maintaining performance. This dual approach allows QLoRA to balance computational efficiency with adaptability, making it an ideal choice for resource-constrained environments or tasks requiring frequent updates to new domain-specific requirements.

The flexibility of QLoRA lies in its ability to maintain the pretrained model's core knowledge while enabling domain-specific customization through lightweight, trainable matrices. By retaining the base model in its original state, QLoRA facilitates iterative fine-tunings across multiple domains without the need for full retraining or risking catastrophic forgetting of prior knowledge. Additionally, the quantization process not only improves memory efficiency but also accelerates inference and training times, making QLoRA particularly valuable for real-time applications like video-language learning models, where rapid processing and contextual adaptation are crucial. This method has transformative potential in scenarios where both adaptability and computational efficiency are paramount, showcasing a significant leap in the evolution of fine-tuning techniques for large-scale AI models.

Embodiments of the inventive subject matter leverage continuous and ad hoc inference strategies. Inference strategy in the context of Video-Language Learning Models (VLLMs) refers to methodologies or approaches used by these models to interpret and generate outputs from video and textual data. A properly trained VLLM can perform complex tasks such as recognizing and understanding objects, scenes, and textual information within videos. It can also provide detailed context-aware responses to prompts, identify spatial relationships, and generate knowledge graphs for scene understanding.

A knowledge graph is an organized representation of real-world people and objects how those people and objects relate to each other. Each relationship and each person or object can have properties. FIG. 7 includes an example of a knowledge graph that features information about a person, a dog, a bag, and a bicycle. Lines stemming from the person indicate how that person bubble indicate how the person relates to each of the other objects. For example, the person is “near” the dog, the person is “carrying” the bag, and the person is “riding” the bicycle. Each of the objects is also associated with additional information. For example, the dog is classified as being white and a bulldog, the bag is classified as being red and a backpack, and the bicycle is classified as being blue and located on grass. A knowledge graph can be stored in a graph database.

Storing information in knowledge graphs is required to easily support complex user queries in text-based information retrieval (Retrieval Augmented Generation i.e. RAG, a simpler version of which could be built using vectorized text). Complex queries either require joins on multiple tables, or multi step retrieval. Such queries are better supported by a graph database. RAG when performed on graph database is referred to as GraphRAG.

Inference strategies can include real-time processing, integration of visual and textual prompts, and leveraging large-scale grounding and captioning data to interpret scenes holistically. These strategies enable VLLMs to carry out nuanced tasks that traditional models cannot easily handle, such as answering domain-specific queries, understanding spatio-temporal interactions, or associating text with objects in a scene. By employing these strategies, VLLMs offer flexible and dynamic solutions for interpreting video content across diverse domains.

With continuous inference, key frames are selected from a video continuously (e.g., at some pre-defined key frame sampling rate) and then passed through the scene understanding module where they encounter a VLLM in Tier 3. The VLLM thus receives each key frame and analyzes the key frames according to a prompt. Input frames can range from 8-256, depending available resources. Continuous inference can be advantageous because it ensures that an entire video stream is considered by the VLLM.

With ad hoc inference, key frames are only subject to VLLM analysis (i.e., Tier 3) when some condition is met in a previous tier. For example, key frames are selected according to some key frame sampling rate, and when Tier 1 analysis indicates a certain object or activity is present or taking place, (e.g., by Tier 1 of a scene understanding module), that motion is detected, or that any other algorithmic condition is met (e.g., an object in the frame not moving for certain period of time), then the key frame will be allowed to continue on to Tier 3. Otherwise, the key frame is not passed on to Tier 3 to save computational resources, thereby improving system efficiency by eliminating the use of a VLLM. Ad hoc inference can be beneficial when, e.g., there are limited resources or large number of cameras need to be supported. One drawback of ad hoc inference, though, is that it can be prone to missing portions of videos.

A VLLM can be used to generate inferences based on a variety of prompts. For example, a descriptive style prompt asking, “Describe the video in detail” can result in a detailed video description. A question style prompt asking, “Is there any suspicious activity in the video?” can generate an output comprising an answer to the question in the prompt. And a multi-question style prompt can also be posed in a single prompt. For example, a prompt that asks, “Answer the following questions and return a JSON: 1. Is there any suspicious activity in the video? 2. Is there any person carrying a red briefcase?” can result in generation of a JSON that includes answers to both questions.

A VLLM can also be used to generate inferences in a conversational manner where questions are provided sequentially one after the other, with answers being generated therebetween. But this results in higher latency, making it impractical for real-time inference generation. What type of prompt should be used will frequently depend on the circumstances of each use case. For example, a descriptive prompt can be useful in most cases to extract as much contextual information as possible. A question style prompt can be useful to focus in on some specific object or event, and a multi-question tyle prompt can be useful when focus should be on more than one object or event. VLLMs should be fine-tuned for each type of prompt for each domain adaptation.

Thus, on the left side of FIG. 7 are two boxes, Frames 700 and Text Prompts 702. Frames 700 features key frames that have been subject to preprocessing and have been re-streamed so they can be passed to VLLM 704. VLLM 704 exists within Tier 3 of a scene understanding module of the inventive subject matter, so it should be assumed that the re-streamed key frames have also been subject to Tiers 1 and 2 as needed. In some embodiments, Frames 700 can comprise raw, unprocessed frames that at streamed at their original FPS, allowing for real time processing of video content. This type of real time processing can occur, for example in a system whereby the VLLM can carry out its tasks within an amount of time that exists between frames in a video stream.

VLLM 704 also receives prompts from Text Prompts 702. Text prompts can be generated via user input, or they can be pre-defined and applied according to domain. For example, the schematic in FIG. 7 is directed to a domain-specific embodiment that focuses on monitoring a work site that can have a supervisor and that can have trucks. Three text prompts are included in Text Prompts 702. One prompt is considered a “descriptive” prompt and it instructs the VLLM to “describe the video in detail.” The other two prompts are considered “QA” prompts, and they ask, “is there a supervisor present?” and “is there a trust with number 678?”

VLLM 704 thus receives the preprocessed key frames from Frames 700 along with the prompts from Text Prompts 702 so the VLLM can generate an Output 706. Output 706 is then shown visually as being broken into three different categories: raw text, chunk vectors, and knowledge graphs. Output from a VLLM can be or be included in a detailed frame document as described elsewhere in this application. Thus a scene understanding module of the inventive subject matter can output a detailed frame document that includes or is the output from a VLLM. This output can be formatted as, e.g., a JSON.

Raw text output from a VLLM can include text that is identified in a key frame by, e.g., OCR. Traditional OCR models can detect bounding boxes of text and recognize the text, but they typically fail to gather information to determine whether the detected text is on a poster, a billboard, a car, road or on a person's clothing. A traditional solution to this would be to add an object detector and check for each text detected whether its bounding box overlaps with that of any object, but this approach is overly restrictive because object detector models are limited to only detecting certain classes of objects. In other words, all objects would need to be pre-defined. And object detectors output bounding boxes, so a class like “road” would not be properly labeled, since a “road” that spans an entire key frame could not be effectively bounded. Segmentation models can instead be used for these kinds of classes, but again segmentation models will need to be trained for each class that needs to be segmented. Furthermore, if some other aspect of text is required, such as color, a text color classifier model would need to be trained. Thus a pipeline that does not use a VLLM would need to be carefully configured and models need to be fine-tuned.

But a properly trained VLLM is not subject to these same limitations. Current VLLMs are trained on large amounts and different types of OCR data. VLLMs can not only recognize the text, but they can also identify its location, color, style, etc. Thus, text can be both recognized for its content but also recognized for where it is seen. For example, the side of a truck can have text that a VLLM recognizes both for what it says but also with the information that the text appears on the side of a truck. This level of text understanding can make it possible for, e.g., prompts to ask, “do any trucks say, ‘SHIPPING LLC’ on the side?” A properly trained VLLM could answer that prompt.

Similarly, traditional models can detect a bounding box of a person. But to get an understanding of interaction with the scene, other models would need to be run and rules would need to be written. Traditional models can also recognize limited person attributes (e.g., upper wear type and color, lower wear type and color), and actions (e.g., standing, walking, etc.). But traditional models can output only a fixed number of classes. For each new attribute, a new model needs to be fine-tuned to accommodate the new attribute and output a new class. VLLMs, on the other hand, can include large amounts of grounding data (e.g., to locate objects in the scene) and captioning data (e.g., to describe a scene) to understand spatial relation between objects in a video.

A “chunk vector” refers to a representation format used to organize and interpret data extracted from video content by domain-specific VLLMs (Video-Language Learning Models). Chunk vectors feature segmented or processed portions of video data, allowing for efficient analysis, storage, or integration into knowledge graphs and other data structures that support scene understanding and decision-making.

Thus, specific systems and methods directed to the use of artificial intelligence to interpret video content in real time have been disclosed. It should be apparent, however, to those skilled in the art that many more modifications besides those already described are possible without departing from the inventive concepts in this application.

The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

What is claimed is:

1. A method of selecting frames from domain specific video content, preprocessing the frames, and analyzing the domain specific video content based on the frames, the method comprising the steps of:
receiving, at a frame preprocessing module, video from a camera, wherein the video comprises content that is specific to a domain;
selecting key frames from the video at a key frame sampling rate;
applying at least one preprocessing technique to each of the key frames;
streaming, from the frame preprocessing module, preprocessed key frames to a scene understanding module comprising a first tier, a second tier, and a third tier;
isolating, in the first tier, an object in the video by detecting the object in at least one preprocessed key frame and segmenting the object into a segmented object image;
vectorizing, in the second tier, the segmented object image to create a vectorized object image;
using, in the third tier, the vectorized object image to generate a contextual description of the video using a domain specific VLLM that is fine-tuned according to the domain of the video; and
wherein the scene understanding module outputs a detailed frame document comprising at least a portion of the contextual description generated in the third tier of the scene understanding module.

2. The method of claim 1, wherein the domain specific VLLM comprises an image encoder that is fine-tuned via a dataset specific to the domain.

3. The method of claim 2, wherein the domain specific VLLM comprises a language model that is fine-tuned via the dataset specific to the domain.

4. The method of claim 3, wherein the dataset comprises images of domain-specific objects and information about domain-specific activities.

5. The method of claim 1, wherein the domain specific VLLM has been fine-tuned using a Parameter-Efficient Fine-Tuning (PEFT) technique comprising Low-Rank Adaptation (LoRA) or Quantized Low-Rank Adaptation (QLoRA).

6. The method of claim 1, wherein the domain specific VLLM is configured to create a knowledge graph, and wherein the detailed frame document further comprises information from the knowledge graph.

7. The method of claim 1, wherein the step of using the domain specific VLLM in the third tier to generate the contextual description further comprises providing the domain specific VLLM with a query that is used in generating the contextual description.

8. The method of claim 7, wherein the query comprises at least one of a descriptive prompt, a question-answer prompt, and a multi-question prompt.

9. A method of selecting frames from domain specific video content, preprocessing the frames, and analyzing the domain specific video content based on the frames, the method comprising the steps of:
receiving, at a frame preprocessing module, video comprising content that is specific to a domain;
selecting key frames from the video at a key frame sampling rate and applying at least one preprocessing technique to each of the key frames;
isolating an object in the video by detecting the object in at least one preprocessed key frame and segmenting the object into a segmented object image;
vectorizing the segmented object image to create a vectorized object image;
using a domain specific VLLM to generate a contextual description of the video using the vectorized object image, wherein the domain specific VLLM has been fine-tuned according to the domain of the video; and
outputting a detailed frame document comprising at least a portion of the contextual description.

10. The method of claim 9, wherein the VLLM comprises an image encoder that is fine-tuned via a dataset specific to the domain.

11. The method of claim 10, wherein the VLLM comprises a language model that is fine-tuned via the dataset specific to the domain.

12. The method of claim 11, wherein the dataset comprises images of domain-specific objects and information about domain-specific activities.

13. The method of claim 9, wherein the domain specific VLLM has been fine-tuned using a Parameter-Efficient Fine-Tuning (PEFT) technique comprising Low-Rank Adaptation (LoRA) or Quantized Low-Rank Adaptation (QLoRA).

14. The method of claim 9, wherein the domain specific VLLM is configured to create a knowledge graph, and wherein the detailed frame document further comprises information from the knowledge graph.

15. The method of claim 9, wherein the step of using the domain specific VLLM in the third tier to generate the contextual description further comprises providing the domain specific VLLM with a query that is used in generating the contextual description.

16. The method of claim 15, wherein the query comprises at least one of a descriptive prompt, a question-answer prompt, and a multi-question prompt.
